(19) United States
(12) Patent Application Publication
(10) Pub. No.: US 2007/0172661 A1
(43) Pub. Date: Jul. 26, 2007

(54) Antimicrobial glass and glass ceramic surfaces and their production

(76) Inventors: Jorg Fechner, Mainz (DE); Jose Zimmer, Ingelheim (DE); Bernd Schultheis, Schwabenheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/569,575

(22) PCT Filed: Sep. 30, 2004
(86) PCT No.: PCT/EP04/10922

§ 371 Date: Dec. 15, 2006

(30) Foreign Application Priority Data
Sep. 30, 2003 (DE) 103 45 815.8

(51) Int. Cl. B32B 17/00; B05D 5/00; B05D 3/00; B05D 3/02; B05D 1/18; B05D 7/00

(52) U.S. Cl. 428/409; 428/410; 427/430.1; 427/421.1; 427/355; 427/256; 427/372.2; 427/299

(57) ABSTRACT

The application relates to an article having a antimicrobial surface with a metal ion concentration, especially a Ag-concentration in a depth of about 0 um to about 2 um of the article measured from the surface higher than 0,6 wt %, preferably 0,8 weight-%, most preferably 1 weight-%.

### FIELD OF THE INVENTION

This invention relates to glass and glass ceramic substrates, glazes and enamels with antimicrobial surface properties, a method to prepare such surfaces and the applications of antimicrobial substrates. The antimicrobial efficiency is generated by one or more metal ions which are implanted on and/or into the glass or glass ceramic surface. Application fields are e.g. food contact ware, kitchen ware, bathroom ware, displays, touch display, food displays, food production, pharmaceutical production, pharmaceutical packaging, medical devices, fresh water treatment, storage and conduction, food storage, cutting boards, counter tops, refrigerator shelves, white goods, table ware, hospital equipment.

### BACKGROUND OF THE INVENTION

From JP2001192234 an inline spray technology of solutions which contain silver or zinc salts for antimicrobial or water repellent characteristics onto a soda lime glass-surface is known. Zn was only applied for water repellence and not to provide an antimicrobial effect to the glass substrate. The combination of Zn and Ag-ions to provide antimicrobial properties for a glass surface are not mentioned. Only the spraying of Ag as an antimicrobial agent onto the surface at 250° C. with a concentration of 0,1 weight-% in water is mentioned in this application.

Because by the spraying technology only a non perfect wetting of the surface of the substrate with the antimicrobial agens could be achieved, with the process disclosed in JP 2001192234 the antimicrobial effect of the surface is not perfect homogenous.

In JP 316320 an ion exchange process with fused salts for soda lime glasses is described. A substrate in JP 316320 soda lime glasses or alkaline containing glasses are used.

Antmicrobial glass-powders have been made known from several patent applications. For example WO 03/018498 describes a antimicrobial glass-powder comprising a iodine-content greater than 10 ppm. From WO 03/018499 a antimicrobial glass powder has made known comprising a glass with a phosphor content lower 1 weight-% within the glass-composition.

From U.S. Pat. No. 5,290,544 water-soluble glasses comprising a concentration of more than 0,5 weight-% Ag have been made known. This glasses provide for antibacterial effect due to the release of the Ag-ions out of the glass-matrix. The glass has a high B₂0₅ and a low SiO₂-content.

From U.S. Pat. No. 6,143,318 phosphat-glasses containing silver has been made known, which also provide an antimicrobial effect.

Antimicrobial borophosphatglasses or borosilicatglasses are described in JP10218637, JP08245240, JP07291654, JP03146436, JP2000264674 or JP2000203876.

Glasses with an antimicrobial effect and a phosphor-content of more than 1 weight-% are known from WO 01/03650.

Coatings for anti-microbial refrigerator shelving have been shown in WO 02/40180. According to WO 02/40180 an anti-microbial agens is added to a matrix containing an epoxy-acrylate resin, an adhesion promoter and a free-radial photo initiator. The matrix comprising the anti-microbial agens is then deposited as a coating onto the glass-substrate. The coating has a thickness of approximately 20 microns. In order to make the coating more stable, especially to prevent abrasion, the coating is cured, especially with UV-light.

Antimicrobial interior refrigerator-articles such as antimicrobial refrigerator shelves according to WO 02/40180 have the disadvantage, that their production is time consuming and furthermore although the shelves are cured an abrasion cannot totally prevented.

From WO 02/32834 an antibacterial glazing is made known comprising antibacterial metal-ions.

EP 0 942 351 B1 shows a glass-substrate for a touch screen sensor. The surface of the glass substrate shows an antibacterial effect due to a coating comprising silver metal ions.

EP 1 270 527 shows a product with a glass layer. In the glass layer shown in EP 1 270 527 a antibacterial effect was obtained by an ion exchange from an alkali ion or alkali earth metal ion, which exists in that glass layer with a metal ion. EP 1 270 527 further shows that the antibacterial metal ions form a layer in the bulk material having a high concentration of metal ions at the surface of the glass layer. No temperature dependence of the ion exchange reaction with regard to the glass substrate is described.

A disadvantage of low processing temperature in an ion exchange process is that the processing times are very long and/or a long term release of silver ions is difficult to achieve. The Ag ions are removed from the surface layer very fast in a washing processes. Also the processing times are very long as the diffusion of the silver into the glass takes a longer time at lower temperatures. US 2002/001604 shows an glass article, wherein an antibacterial, antifungal or antialgal component has been diffused from a surface into the inside of a surface portion of the article. For a silver colloid dispersion having a silver component for a soda lime glass a antibacterial surface after a heat treatment for about 500° C. for 30 minutes was found. The application does not describe how other glass substrates such as borosilicate-glasses can be provided with a antibacterial surface, nor how deep metal-ions have been diffused into the surface or how the process parameters must be chosen to provide a antimicrobial surface for which by a ASTM 2180-test a reduction of microorganisms by two log scales is shown. The processing times of 30 minutes are very long and not suitable for fast mass production. Combinations of different antimicrobial ions are not described.

### SUMMARY OF THE INVENTION

In view of the foregoing and other limitations and disadvantages of the prior art, it is an object of the present invention to provide an improved article with an antimicrobial surface and an improved process for the production of antimicrobial glass and glass-like substrates.

Examples for microbials are bacteria, fungus, yeast, mold, algae and virus.

It is a further object to provide a material with a defined antimicrobial component such as Ag, Zn, Cu , Sn, I, Cr, Te, Ge in metallic and/or ionic form with a antimicrobial effective concentration at the surface of the substrate, especially the surface of a glass substrate. This surface has also a long term efficacy and efficacy after cleaning and washing.

In a preferred embodiment the material with a defined antimicrobial component such as Ag, Zn, Cu, Sn, I, Cr, Te, Ge has a concentration profile which shows a high concentration at least at one surface of the substrate. Preferably the concentration of antimicrobial ions decreases in direction of the substrate depth.

For special applications the material has a concentration profile with a relatively low concentration of antimicrobial components, such as Ag, Zn, Cu-ions directly at the surface of at least one surface of the substrate. In this special case the concentration of antimicrobial ions increases directly under the surface for a short distance and then decreases to zero.

It is another object to provide a process for preparing a transparent, essentially colorless substrate, especially glass- or glass-like substrate or glass-ceramics having an antimicrobial effective concentration of metal ions in at least one selected surface region thereof.

It is another objective to provide a process for preparing colored antimicrobial glass and glass-ceramic substrates.

Yet another object is to provide articles having at least one substantially flat glass or glass-like surface having a contact-killing, non-leaching antimicrobial effective amount of metal ions at the surface of the flat glass or glass-like surface.

In this application the term “non leaching” means that in a Hemmhof Testing (EN 1104) no significant antimicrobial efficacy against e. g. Aspergillus Niger and Bacillus Subtilis can be detected.

The Hemmhof-Test is an Agar-Diffusion test according to EN 1104. In this test the sample is placed in Agar, which contains a defined germ concentration. Measured is the distance around the sample where no germ growth occurs in mm.

Another object is to provide devices, and particularly devices that are intended for use as food contacting articles. The aforementioned articles have at least one food contacting surface. The food contacting surface comprises a transparent, essentially colorless glass or glass-like material having an antimicrobial effective concentration of metal ions at least in the surface region of the glass or glass-like material.

In the case of Ag-ions as antimicrobial agents normally the antimicrobial effect decreases while the coloring increase if the amount of Ag is constant. The coloring effect results from silver clusters of metallic silver. Metallic silver has no antimicrobial effect, whereas silver ions have an antimicrobial effect. If the amount of Ag is kept constant and the amount of silver cluster increases then coloring increases whereas the amount of silver ions decreases an thus the antimicrobial effect decreases.

It is advantageous if the antimicrobial substrate is essentially colorless for short term effects. In case the antimicrobial substrate is colorless, the antimicrobial substrate comprises a high amount of antimicrobial effective silver ions and a low amount of silver clusters.

As mentioned before the color of the substrate mainly is provided by metallic silver cluster, whereas as stated above only ionic silver has antimicrobial properties. If a discolorisation of the substrate occurs, it is as stated above a sign for decreased short term antimicrobial-efficacy.

For long term antimicrobial efficacy of the surfaces in specific applications it can be advantageous to have beside ionic silver also metallic silver as nanoparticles (e. g. “silver cluster”) in the glass matrix. In this case the nanoparticles should be close to the surface, so that they can release silver ions. The nano particles are acting as a release system for silver ions. Silver ions could be provided from metallic silver e. g. by oxidation.

Nevertheless for specific applications such as cook tops, refrigerator shelves, glass tubes a substrate having a specific color can be favorable.

If this color is induced by the generation of ion diffusion and formation of nano particles like silver this color can be varied by a variation of the number and size of the nano particles. In the case of silver the nano particles typically have particle sizes which are lower than 30 nm, preferred lower than 20 nm, more preferred lower than 10 nm, most preferred lower than 5 nm. Typical colors which can e. g. be achieved are in the yellow and red range.

It is a further object of the invention that with the inventive process all different sorts of substrates, especially glass-substrates and glass-ceramic-substrates can be provided with an antimicrobial surface, and the process is not limited e. g. to a float glass substrate.

With the inventive process alkali containing floatglass such as e.g. Borosilicate-glasses (e. g. Borofloat 33, Borofloat 40, Duran, of SCHOTT AG, Mainz) as well as alkaline free glass (e. g. AF37 or AF45 of SCHOTT AG, Mainz), Alumosilicate-glasses (e. g. Fiolax, lllax, of Schott Mainz), Alkline Earth Alkaline glasses (e. g. B270, BK7 of SCHOTT AG, Mainz), Li₂O-Al₂O₃-SiO₂-float glass and in a more specific application Soda lime float glasses should be used as substrates. In preferred embodiment display glasses such as D263 of SCHOTT-DESAG, Grünenplan can be used as substrate. In principal the inventive process is applicable with all technical and optical glasses as a substrate material.

With the inventive process glass ceramics such as e.g. Lithiumaluminosilicate Glass ceramics (e. g. Ceran, Robax, Zerodur of SCHOTT-Glas Mainz) or Magnesiumaluminosilcate Glass ceramics or Mica Glass ceramics can be provided with an antimicrobial surface.

In a most preferred embodiment, the parameters of the process are chosen in such a way, that the antimicrobial surface provided by the inventive process fulfill the antimicrobial requirements according to ASTM E2180-01 and/or JIS Z2801.

In a further preferred embodiment the antimicrobial surface fulfills ASTM E2180-01 and/or JIS Z 2801 and shows no “Hemmhof” formation according to EN 1104 and fulfills the non leaching results required for food contact materials according to German Law (LMBG) and/or drink water requirements as the German drinking water law (“Trinkwasserverordnung”) § 11 which allows for a release of Ag at maximum of 0,08 mg/l.

Substrates can be e. g. flat glass, glass tube, glass, lenses, ampulles, karpulles, bottles, cans, glass screens and other randomly shaped glass parts.

Further substrates can be e. g. glass ceramics in flat or curved form or glass tubes.

It is a further object of the invention to provide a process for preparing antimicrobial colored and non colored glass ceramics.

Preferably glasses with an antimicrobial surface are provided. The glasses can be produced by a float process or a non float processes.

### DETAILED DESCRIPTION

In a first embodiment of the invention a antimicrobial surface is obtained by applying in a first step a metal ion precursor material onto the surface of the substrate, especially the glass or glass-like or glass-ceramic substrate in any convenient manner, such as, for example, by dipping, spraying, screening, brushing or the like techniques.

The metal ion precursor material is a dispersion or solution or mixture of a metal ion precursor in suitable solvents, liquids or dilution substances.

The metal ion precursor can be e. g. Inorganics like Nitrates, Chlorides, Sulfates, Phosphates, Sulfides or Oxides. Also metal-organic or metallic precursor materials like nanoparticles can be used. These components can be dissolved and/or dispersed in a solution.

In a preferred embodiment totally soluable precursors are used to achieve most homogenous distribution of the antimicrobial agents on the glass surface.

The penetration depth into the glass for different precursors and precursor formulations are different. E. g. for silver salts it was found that the penetration depth decreases from Ag₂SO₄, AgNO₃, Ag₂O, to Ag₃PO₄. By mixing different precursor specific diffusion profile properties can be achieved. The salts are also different with respect to color formation. Normally AgNO₃ and Ag₂SO₄ show stronger color formation than Ag₂O and Ag₃PO₄.

Therefore by choosing mixtures of precursor antimicorbial long and short term efficacy, the ion profiles of the surface layer and color formation can be designed and optimized.

After the metal ion precursor material, containing antimicrobial metal ions such as Ag, Zn, Cu, Sn, Cr, l, Te or Ge and/or compounds with these metals is applied to at least one surface of the substrate, the substrate is heated to a temperature sufficient that during the heating process the antimicrobial precursors and solvents are decomposed and/or evaporated and the antimicrobial ions are penetrating or bonding into/to the substrate, e. g. the glass surface or the glass-ceramic surface by diffusion and/or ion exchange.

This can be done in an one step process or in a multi step process. In a multi step process advantageously specific antimicrobial ion distributions and profiles in the glass, glass-ceramic or glass-like material are obtained. The process of heating the substrate to decompose and/or evaporate the antimicrobial precursors and/or solvents can combined with other temperature treatments of the substrate. Such temperature treatments of the substrates are e. g. a chemical strengthening process a forming process and/or a mechanical strengthening process and/or a coating process and/or a decoration process.

In a two step process as an example for a multi step process the substrate, which is preferably amorphous glass is heated to a first temperature sufficient to drive off any volatiles contained in the antimicrobial metal ion precursor, which lies in a first embodiment within the range from about a temperature depending on the solvent and precursor-material from about 30° C.-250° C. and then heating the resulting substrate to a second temperature, which lies in a first embodiment within the range from T(g)−300° C. to about T(g)+250° C. for a short period of time, e. g. in a first embodiment from about 1 min. to about less than 30 min. T(g) is the transformation temperature of the glass and depends on the glass composition. In preferred embodiment the temperature ranges from T(g) −200° C. to T(g) +200°. The transformation temperature T(g) is well known for a man skilled in the art and e. g. described in VDI-Lexikon Werkstofftechnik (1993), pages 375-376. In a more preferred embodiment the temperature ranges from T(g) −100° C. to T(g) +150°.

By the above mentioned process one can obtain an article, especially a glass-substrate having a antimicrobial surface. The antimicrobial ions are embedded within a surface layer of the substrate. The surface layer has a thickness of about 10 μm. The metal ion concentration within the surface layer decreases from the surface in the direction towards of the substrate, the metal ion concentration within the surface layer is within the first two μm of the surface layer higher than 0,05 preferably higher than 0,5 weight-%, more preferably higher than 1,0 weight-%, most preferably higher than 2 weight-%.

In a preferred embodiment the metal ion concentration within the first two μm of the surface layer is higher than 0,8 weight-%, preferably higher than 1,0 weight-%, most preferably 1,2 weight-%. The ratio of the concentration of the metal ions in a depth of about 1 μm of the surface layer to the concentration in a depth of about 10 μm of the surface layer is greater than 5, preferably greater than 10, most preferred greater than 100.

The most preferred metal ion to be used for preparing a antimicrobial surface according to the invention is silver (Ag). But also other ions such as Zn or Cu or Sn or Cr or I or Te or Ge or combinations of these ions are possible

Combinations of ions can be advantageous if a broad antimicrobial effect against bacterial, yeast and fungus wanted to be achieved or synergistic effects wanted to be used.

E. g. a combination between Ag- and Cu-precursor increases the antimicrobial efficacy against bacteria and fungus and also has an additional advantageous effect on avoiding the color generation by silver nano particles.

Different antimicrobial ion profiles can be achieved by the selection of the glass type, precursor types, surface preprocessing, the temperature time processing and post processing of the surface. Depending of the application and the time dependence of the antimicrobial efficacy following profiles are e. g. possible:
a) constant decreasing ion concentration from surface into bulk
b) constant increasing ion concentration from surface into bulk
c) mixed forms of a) and b) especially nearly constant profiles

These profile can also include different types of antimicrobial ions. In general the type related profiles are different between each other because the diffusion an/or ion exchange rates are different.

In a more preferred embodiment providing for a long term-release of antimicrobial ions the process parameters are chosen such, that the ratio of the average concentration of the antimicrobial metal ions in a depth of about 0,5 μm of the surface layer to the concentration of the metal ions in a depth about 2 μm to about 5 μm of the surface layer is smaller than 0,5 preferred smaller than 0,1, most preferred smaller than 0,01.

In a preferred embodiment with low leaching at relatively high overall metal ion concentration the average concentration of antimicrobial metal ions in the first 50 nm are reduced to the average concentration between 50 nm and 1 μm by about more than 1% more than preferred more than 5% most preferred more than 10%.

In a most preferred embodiment providing for a long term-release of antimicrobial ions the process parameters are chosen such, that the ratio of the concentration of the metal ions in a depth of about 20 nm compared to the concentration of the metal ions in a depth of about 1 μm is smaller than 1 to 1,1 preferred smaller than 1 to 5 most preferred smaller than 1 to 10. Furthermore the ratio of the concentration of the metal ions in a depth of about 10 μm to the concentration of the metal ions in a depth of about 1 μm is smaller than 1 to 5 preferred smaller than 1 to 10 most preferred smaller than 1 to 100.

In a most preferred embodiment providing for a high antimicrobial efficacy at the start conditions the process parameters are chosen such, that the ratio of the concentration of the antimicrobial metal ions in a depth of about 20 nm compared to the concentration of the metal ions in a depth of about 1 μm is greater than 1,1 to 1 preferred greater than 5 to 1 most preferred greater than 10 to 1 and wherein the ratio of the concentration of the metal ions in a depth of about 10 μm to the concentration of the metal ions in a depth of about 1 μm is smaller than 1 to 5 preferred smaller than 1 to 10 most preferred smaller than 1 to 100.

The precursor of antimicrobial metal ions comprises a metal compound, typically a salt, complex or the like, dissolved or otherwise dispersed in a compatible carrier material, wherein the metal compound is capable of exchanging antimicrobial metal ions for metal ions.

Precursors are e. g. inorganic salts of antimicrobial ions, e. g. nitrates, preferably silver nitrate, chlorides, or organic salts such as acetates or mixtures thereof.

The carrier material or vehicle is a liquid or liquid-based material that is capable of dissolving or otherwise dispersing or suspending the metal compound. The carrier material can be water based or alcohol based.

Also organic oils or inorganic oils such as silicon oils as a carrier material or as vehicle are possible materials.

Any residue from the dried precursor material that is not decomposed and burned off the substrate during the ion exchange and/or diffusion heating step, generally is completely removed during the antimicrobial tempering process or can be washed off easily.

The concentration of the source of antimicrobial metal ions in the precursor material may vary over wide limits depending, in part, on the particular metal compounds and the particular carrier materials involved. However, the identity and relative concentrations of the source of metal ions and the carrier material in the precursor materials are important only to the extent that the precursors are capable of exchanging or otherwise implanting an antimicrobial effective concentration of metal ions into the surface regions of the substrate during the present treatment process. Typically, a concentration of Ag, Cu, Zn, Cr, l, Te, Ge compounds in the range of from about 0.01 to about 10.0%, by weight, and preferably from about 0.1 to about 5,0%, by weight, and more preferably from about 0,25 to about 2% by weight based on the total weight of the metal compound and carrier material, will be adequate to provide an antimicrobial effective concentration in the surface regions of a glass or glass-like substrate in accordance with the invention.

The precursor concentration can further on limited by the solubility in the chosen solvent.

In a further preferred embodiment of the invention the inventors found out, that depending on the temperature time profile and the starting surface concentration of the ions different concentration profiles from surface to interior of the substrate can be generated, because during the heating process the antimicrobial precursors are decomposed and the antimicrobial ions are penetrating the glass surface by diffusion and/or ion exchange. If the temperature and time are too high the antimicrobial ions are penetration too deep the bulk material so that the antimicrobial surface effect is too low. If temperature and time are too low fixed antimicrobial ions in the surface can be too low so that the antimicrobial effect is removed e. g. after cleaning with water.

Especially by use of Ag-ions as antimicrobial agent in the case of float glass additionally a yellowing can occur which is caused by the formation of metallic silver nano particles or clusters. The formation of Siver nanoparticles is supported by Sn and/or Fe impurities and the overall redox state in or on the glass surface.

Redox partners like Fe²⁺ or Sn³⁺ are reducing the silver ions. The reduced silver forms silver nanoparticles/clusters which absorb light at about 420 nm which causes a yellow coloring. Therefore the usage of Zn and/or Cu or a mixture of Ag and Zn and/or Cu as an antimicrobial metal ions is preferred if a colorless antimicrobial substrate should be provided. The synergistic antimicrobial effect of different ions is advantageous. An advantageous synergistic antimicrobial effect can be achieved as the mechanisms and locations of reaction of e. g. Ag and Zn-ions are different. Further on a combination of Ag and Cu-salts in the solution is advantageous for the reduction of discoloration especially at higher process temperature where Cu-ions have a higher diffusion rate.

According to a further improved embodiment, the inventors found out, that the first temperature sufficient to drive off any volatilers contained in the antimicrobial metal ion precursor in the two step-process can lie within a temperature range from about 40 to about 250° C. This temperature depends e. g. on the precursor-material or the solvent.

In the first embodiment in a second step the antimicrobial ions are implanted on and/or in the surface of the glass. The inventors found out, that in the further improved embodiment, the temperature of the second step depends on the glass type and furthermore the temperature dependent diffusion coefficients of the antimicrobial ions, which are used to produce the antimicrobial surface. The inventors found out that, the temperature dependent diffusion coefficient of the ions is not only dependent from the sort of the ions, but also from the substrate material used. Therefore the temperature-region for the second process step is also substrate-dependent. The ion exchange and/or diffusion temperature for the second process-step is chosen preferably to be in the range from about 200° C. lower than the glass transformation temperature (Tg) of the substrate, especially the glass substrate to about 200° C. higher than the glass transformation temperature (Tg) of the substrate, especially the glass substrate. More preferably the temperature of the second process step is chosen from about 100° C. lower than the glass transformation temperature of the substrate material to about 100° C. higher than the glass transformation temperature of the substrate material, most preferably about 50° C. lower than the glass transformation temperature point of the substrate material to about 50° C. higher than the glass transformation temperature point of the substrate material. The period of time in which the substrate is heated up to the ion exchange/diffusion temperature which lies in the range given above for the second process step is according to the further embodiment of the invention from about 1 min to about 30 min, preferably from about 1min. to about 15 min most preferable from about 1min to about 5 min.

In an improved embodiment of the invention, the antimicrobial surface of a substrate can be prepared in a one step-process. In a one step process, the substrate is heated up to a temperature sufficient that the antimicrobial ions are implanted on and/or in the surface of the substrate, especially the glass or glass-like substrate. The temperature depends on the substrate type, especially the glass type and furthermore the temperature dependent diffusion coefficients of the antimicrobial ions, which are used to produce the antimicrobial surface. The inventors found out that, the temperature dependent diffusion coefficient of the ions is not only dependent from the sort of the ions, but also from the substrate material used. Therefore the temperature-region for this process-step is substrate-dependent. The ion exchange and/or diffusion temperature for the is chosen preferably to be in the range from about 200° C. lower than the glass transformation temperature of the substrate, especially the glass substrate to about 200° C. higher than the glass transformation temperature of the substrate, especially the glass substrate. More preferably the temperature of the second process step is chosen from about 100° C. lower than the glass transformation temperature of the substrate material to about 100° C. higher than the glass transformation temperature of the substrate material, most preferably about 50° C. lower than the glass transformation temperature (Tg) of the substrate material to about 50° C. higher than the glass transformation temperature of the substrate material. The period of time in which the substrate is heated up to the ion exchange/diffusion temperature which lies in the range given above for the second process step is according to the further embodiment of the invention from about 1 min to about 30 min, preferably from about 1 min to about 15 min most preferable from about 1 min to about 5 min. Also by heating up the substrate to the ion exchange temperature the volatiles of the ion precursor material are driven off the substrate. The one step process has the advantage of a shorter processing time than the two step process.

In the case float glass is used as a substrate material much high silver concentrations can be implanted into the glass without discoloration if the surface layer e. g. contains tin. The tin containing layer is introduced within the production process of the float glass. The thickness of the tin-layer is e. g. about 10-20 nm on the atmosphere side in the float bath and on the bath side several micrometer. Further impurities like iron ions are in the whole glass. The Redox equilibrium of polyvalent ions (e. g. between Fe²⁺ and Fe³⁺) is moved to the reduced side especially in the first micrometers of the glass surface. Also the viscosity (lower viscosities on the reduced side) and therefore the diffusion rate of Ag⁺ is influenced by the redox equilibria in the surface region. Since it is advantageous that Ag⁺ does not diffuse into the depth of the glass a removal of the surface layer which has normally a lower viscosity is advantageous. The removal of the surface layer is furtheron advantageous with respect to the removal of ionic and/or metallic tin as well as ionic iron especially Fe2+, especially if discoloration should not take place.

In the case of float glasses the iron concentration has a direct influence on the tin redox state and concentration in dependence of the depth. The higher the Fe concentrations in the glass, the higher is the formation of the so called “tin hump” in the glass, which means there is concentration maximum of tin inside the bulk material. This “tin humb” is disadvantageous with respect to discoloration. Therefore non discolored float glasses should have iron concentrations lower than 1000 ppm , preferred lower than 500 ppm, more preferred lower than 300 ppm most preferred lower than 100 ppm and 50 ppm.

Depending on the side which shall be treated with the antimicrobial layer different removal technologies have to be used.

The removal and cleaning of the surface-layer can be done e. g. by chemical, etching or mechanical removal. Chemical etching can be done with different inorganic or organic acids and/or bases and with combinations oft them. Acids can be e.g. HF, HCI, HNO₃,. Bases can be alkaline or earth alkaline hydroxide (e. g. NaOH). Additionally oxidizing treatments with e. g. H₂O₂ or the use of Peroxy-salts like Earth alkaline peroxides (e. g. CaO₂ or ZnO₂) or heating in O₂ -containing atmosphere can be done to avoid discoloration effects by reduction.

In the case of float glasses an oxidizing heat treatment in oxygen containing atmosphere can significantly reduce the yellowing effect. This is due to the redox state change in the glass surface which influence the reduction potential of Ag-ions and the diffusion rate of Ag-ions in the glass.

To avoid silver induced discoloration further compounds which contain and introduce polyvalent ions on or in the glass surface can be used to reduce the discoloration effect. Polyvalent ions can be e. g. of element Ti, Cu, Ce, Cr, Mn, V, Bi, Mo, Nb, Co, Zn, As and Sb. By combination of these ions with e. g. NO₃-salts and processing parameters is possible to reduce discoloration by changing diffusion rates and mechanical strength.

Precious metals such as Pd, Pt and Au could be added as salts or oxides to the glass. The advantage of such precious metal combinations could be seen by oxidation of reduced silver to metallic silver.

Mechanical removal can be done by standard grinding and polishing techniques in inline or off line production processes. Low cost touch polishing processes are preferred.

For the float bath side mechanical removal is preferred as the tin containing layer can be several micrometer thick.

On the float bath side typically less than 200 um are removed preferred less than 100 um most preferred less than 10 um less than 1 um.

On the atmosphere side typically less than 50 less than 10 less than 1 um less than 100 nm are removed.

If the surface layer of float glass is removed extremely high silver salt concentrations can be applied with solutions and/or dispersions on the surface and high treatment-temperatures could be realized without any discoloration of the glass. No discoloration was found up to surface concentrations of more than 15 weight-%.

Since the usage of alkaline containing glasses such as soda lime float glass with a temperature of the glass transformation temperature T(g) from about 525° C. to 545° C. as a substrate is preferred, the process is not restricted on soda lime glass or alkaline containing glasses and the related ion exchange process, because the diffusion coefficients of the dfferent antimicrobial ions are high enough at the selected processing temperatures and times, so that they can penetrate the glass surface also of other glasses, such as Borosilicate glasses (e. g. BF33, BF40 from SCHOTT), Alumosilicate glasses (e. g. FIOLAX, Illax from SCHOTT) alkaline free Alumosilicate glasses (e. g. AF37, AF45 from SCHOTT). The glass transformation temperature T(g) of Borosilicat-glasses lies within the range from about 460° C. to about 600° C., for Alumosilicat-glasses from about 550° C. to about 700° C. and for alkaline free Alumosilicat glasses from about 650° C. to about 800° C.

Surprisingly the process is not only limited to Alkaline containing glasses where an ion exchange process between e. g. Sodium and Silver supports the movement of silver ions into surface. Obviously also by normal diffusion process the silver ions will penetrate the surface if temperatures are high enough.

Also glass-ceramics can be used as substrate-material. In the case of glass ceramics as a substrate material the inventors found out that the processing temperature of the diffusion step of the metal-ions into the glass surface is dependent from the ceramization temperature of the glass ceramic and the glass transformation temperature T(g) of the residual glass phase. Preferably the processing temperature lies in a region from about 300° C. lower than the crystallization temperature and about 200° C. higher than crystallization temperature. More preferred are temperatures in a range from about 200° C. lower than crystallization temperature to 100° C. higher than crystallization temperature. Most preferred are temperatures which lie in the range from about 50° C. lower than crystallization temperature to about 50° C. higher than the crystallization temperature.

Typical glass ceramics which can be used are alkali containing glass ceramics like e. g. Lithiumaluminosilicate (LAS) glass ceramics like CERAN ®, ROBAX ® or Zerodur ® (all trademarks of SCHOTT-GLAS, Mainz) but also alkaline free glass ceramics like Magnesium Aluminium silicates (MAS).

The antimicrobial precursor can be applied before or after the ceramization process. In case the ion exchange process or the diffusion process is combined with the ceramization process only one process step for ion exchange diffusion and ceramization is necessary.

If the substrate after the ion exchange or diffusion is cooled down rapidly (e. g. by blowing air) a glass-substrate can be mechanical strengthened. The process steps are the same process steps as described above for glass substrates as substrate material.

In a specific form of the invention it is highly advantageous to define the temperature time profile of the diffusion step in such a way that rapid cooling generates a mechanical strengthened substrate. It is further advantageous to define the temperature profile in such a way that surface decoration treatments can be done parallel in the same process. It is most advantageous if all three processes (antimicrobial treatment, decoration treatment and mechanical strengthening treatment) can be done in one process-step.

The inventors further found out in a most preferred embodiment of the invention that, if one uses a Ag-salt as a metal ion precursor, a combination of Ag-salts as a metal ion precursor material with salts of other polyvalent ions can reach a reduction of the yellowing. For example a combination of a Ag-salt with e. g. a Cu-salts can reduce coloring. Most preferred salts have oxidizing properties like Nitrates or Peroxides.

Also a combination of different ion-precursor materials can be used. This can be advantageous e. g. if the antimicrobial properties should be combined with water repellent properties. In this case Ag-salts as a precursor material and Zn-salts as a further metal ion precursor material can be combined. Such a combination is most preferred in case a high antimicrobial effect should be achieved without coloring.

In such a case to achieve a high antimicrobial effect Ag-salts as a first metal ion precursor material can be combined with Zn-salts as a second metal ion precursor material.

Furthermore by combination of different metal ion precursor materials an synergistic antimicrobial booster effect can also be achieved e. g. by combining different antimicrobial ions such as ions of e. g. Ag, Cu, Zn, Sn, l, Te, Ge, Cr.

In case a colored glass or glass ceramic is used discoloration effects are of lower importance.

It is also possible to add specific coloring agents to the antimicrobial ion containing solution.

In a improved embodiment the inventors found out, that if a suspension is used as a carrier material for the metal ions the particle size of inorganic antimicrobial substances should be lower than 1 um preferred lower than 0,5 um most preferred lower than 0,1 um. This is especially necessary if a homogenous, non speckeled surface should be achieved.

The application of the metal ion precursor material or materials onto the substrate, especially the glass substrate in a preferred embodiment of the invention is done at room temperature or temperatures slightly higher than room temperature. If a two step process is used the coating could be dried in a first tempering step.

In a preferred embodiment the concentration of a Ag-metal compound in a metal ion precursor material in the range of from about 0.01 up to about 4% by weight, and preferably from about 0.25 to about 1,5% by weight, based on the total weight of the metal compound and carrier material, will be adequate to provide an antimicrobial effective concentration in the surface regions of a glass, glass-ceramic or glass-like substrate in accordance with the invention.

For Zn-metal or Cu-metal compounds Zn-metal or Cu-metal compound in a metal ion precursor material in the range of from about 0.01 up to about 20% by weight, based on the total weight of the metal compound and carrier material, will be adequate to provide an antimicrobial effective concentration in the surface regions of a glass or glass-like substrate in accordance with the invention.

The term “antimicrobial effective concentration”, as used in this specification and claims, means that ions, atoms, molecules and/or clusters of the antimicrobial metal which has been exchanged or otherwise implanted into the surface regions of the glass or glass-like substrate are present in the surface regions of the substrate in a concentration such that they are released from the surface of the substrate at a rate and in a concentration sufficient to kill, or at least to inhibit microbial growth, on contact. To achieve this in a preferred embodiment the release rate of the metal ions providing for the antimicrobial effect is such that it fulfills the requirements of the LMBG (German Food law) and shows not Hemmhof”. This means that in a Agar-diffusion Test (the so called “Hemmhof”-test EN 1104) against Aspergillus Niger and Bacillus subtilis no release or diffusion from the antimicrobial surface should be seen.

As heating technologies for reaching the temperatures for the different process steps the following techniques could be used: standard roller furnaces, batch furnaces, IR-heating, laser heating, gas burner heating, microwave heating. Since only a surface treatment of the substrate is performed preferably only the temperature directly at the surface of the substrate has been monitored, e. g. risen. This can e.g. be done by specific heating technologies like IR or Laser heating.

Especially the Laser heating technology can be used to provide for structured antimicrobial surfaces e. g. for biological applications. They can be combined with standard heating technologies.

As used herein the term “non-leaching antimicrobial glass or glass-like surface” is meant to describe a glass or glass-like surface, e. g., ceramic or glass-ceramic surface, that contains antimicrobial metal ions that are released from the surface at a rate sufficient to render the surface antimicrobially effective, while at the same time being released slowly enough for the glass surface to remain antimicrobially effective for an extended period, even when subjected to washing, e. g., in a conventional dishwasher.

In preferred embodiment these surfaces pass the Hemmhof Test and the leaching requirements of German LMBG Law.

After the final heat treatment process a washing step of the glass surface can be conducted to remove debris from the coating solution from the glass and adjust the antimicrobial agent concentration directly at the surface e. g. to fulfill the required German LMBG constrains. Such a step is especially necessary if high antimicrobial agent concentrations have to be achieved inside the glass to generate a long term antimicrobial effect. The heat treatment is done with solutions with so high antimicrobial ion concentrations that without washing the ion release directly from the outer surface is too high to fulfill e. g. Hemmhof test and LMBG requirements for food contact materials.

Beside the ion concentration and release also the specific surface area plays an important role with respect to the antimicrobial efficacy. The surface area can e. g. be modified by grinding and polishing processes and influences directly the ion release. This can also be combined with a different optical appearance like “frosted glass”. Standard grinding technologies cari be used like fixed or loose grain grinding or sand blasting. By increasing the surface area the overall amount of antimicrobial ions can be reduced in the surface by achieving the same antimicrobial efficacy. This can be especially advantageous if additionally discoloration effects should be avoided.

The surface roughness (Ra) is e.g. for rough grinding surfaced is between 5 um and 1 um for fine grinding between 1 um and 0,2 um and for polishing down to about 2 nm. Variation of the surface roughness allows to modify the antimicrobial efficacy e. g. by keeping other process parameters like silver concentration and processing temperature and time constant.

The atmosphere during the temperature processes has an influence of the redox behavior at and in the glass surface. Increased oxygen concentrations are reducing the discoloration which is introduced e. g. by the reduction of silver ions and the formation of metallic silver nano particles. This effect increases with increasing processing temperature as the diffusion rate and depth of oxygen into the glass is growing. On the other side oxygen in the atmosphere supports the generation of metal oxides like Ag₂O at the glass surface. These Oxides are quite stable and are reducing the metal ion diffusion into the surface. These oxides are increasing the surface antimicrobial effect.

In a preferred embodiment the formation of these metal oxides are controlled in such a way that are homogenous spread on the surface and no surface layer can be seen with the human eye. Furthermore the oxides are fixed to the glass surface in such a manner that they cannot be removed by normal cleaning processes like wiping and normal washing. Surface modifications with respect to wetting properties or diffusion properties can be additionally done.

In an alternative embodiment of the invention antimicrobial surface could be provided by ion exchange out of salt baths. With glasses comprising alkali or earth-alkali elements by ion exchange in liquid salt baths with temperatures from about 200° C. to T(g)+100° C., preferred to T(g), more preferred to T(g)−50° C. most preferred to T(g)−150° C. a diffusion of ions like Ag, Cu, Zn, Sn could be achieved. With glasses having no alkali-elements even simpler diffusion processes could lead to antimicrobial surfaces. The temperature of the liquid salt bath depends from the melting point of the glass.

By tempering the substrate after the ion exchange antimicrobial ions can diffuse even deeper into the bulk material. In a preferred embodiment the process parameters are chosen such, that no coloring of the substrate, especially the glass substrate occurs and the substrate has a high transmission in the visible wavelength range.

By again treating a glass-substrate having a surface layer containing an amount of antimicrobial ions e. g. in a salt bath antimicrobial ions can be once more exchanged with e. g. Na-ions. The remaining Ag-ions diffuse even deeper into the bulk material. The Ag-ions are then buried into the substrate.

Between the ion exchanged glass parts and glass parts in which no ions were exchanged stress could occur. This can be used for providing a chemical prestressed glass with a antimicrobial surface.

In case substances for chemical presstressing a glass are combined with a composition comprising an antimicrobial effective metal ion a prestressed glass with an antimicrobial surface is obtained. Advantageously in such a case a glass is chemical prestressed and provided with an antimicrobial surface in only one process step.

To achieve an antimicrobial effect with an ion exchange process very short process times shorter than 60 minutes, preferably shorter than 10 minutes, most preferably shorter than 5 minutes are sufficient.

The temperature for the ion exchange process in a melt bath is preferably lower than T(g) +50° C. Even temperatures as low as the melting temperature of the salt bath are possible.

Beside a salt bath it is possible to apply a melt paste onto the substrate. Especially pastes comprising AgCl, AgNO₃, ZnCl or ZnNO₃ could be applied onto the substrate or alternatively burned into the substrate. After tempering the pastes can brushed away from the surface.

In case of a suitable melting or a suitable temperature profile an ion exchange rate of nearly 100% could be achieved at the surface of the substrate.

Another possibility of bringing metal compounds onto the surface of a substrate is to bring polymers e. g. in the form of foils onto the surface of the substrate. By thermal processes e. g. a thermal heating with a laser, metal ions could be forced to diffuse into the surface. With a laser it is possible to bring a certain structure onto a surface of a substrate.

With the processes described before, it is also possible to provide glass-ceramic surfaces with an antimicrobial surface. Glass ceramics could be treated before ceramization or after ceramization.

The Ag, Zn or Cu containing melts or pastes could comprise e. g.
Ag-chloride
Ag-nitrate
Ag-oxide
Ag
Ag-organic compounds
Ag-anorganic compounds
Cu-chloride
Zn-oxide
Zn-nitrate
Zn-chloride
Cu-, Zn-organic compounds
Cu-, Zn-anorganic compounds
   as well as all other compounds comprising all salts of antimicrobial ions, e. g. Ag, Cu, Sn, Zn, which are stable up to the temperatures of the process.

Zn-compounds are advantageous over Ag-compounds, since Zn does not color the substrate, especially the glass substrate.

The process of providing a antimicrobial surface could be combined with other process steps of glass processing. In an especially advantageous case the process steps of making a glass substrate antimicrobial and prestressing a glass are combined. For making the surface of glasses antimicrobial it is only necessary to add e. g. a silver-salt to the bath which is used for prestressing the glass. Such a processing is used for the manufacturing of hard-disks, glasses for spectacles, thermal prestressed glasses, such as glasses for the use in laboratories.

In order to provide an antimicrobial effect to only one side of a substrate, only this side of the substrate is coated e. g. with a metal-containing paste.

According to a further aspect of the invention an article comprising an antimicrobial surface prepared according to the invention is provided. Particularly the article comprising an antimicrobial surface according to the invention is an article which is intended to contact food. Such an article may be a tray, a shelf, a cook top, a countertop, an eating or drinking utensil or a cutting board.

Also pharmaceutical packaging products with an antimicrobial surface or optical glasses for e. g. medical devices are provided according to the invention.

Other applications for applying the technique of providing a glass-article with an antimicrobial effect are:
Display glasses e. g. touch screens, Baby bottles, nutritional storing water treatment and tubing systems, windows, food display, optical lenses, laboratory glasses, especially from borosilicate glasses. Most preferred are antimicrobial glass-shelve, especially for refrigerator shelving.

One further aspect of the invention is to provide antimicrobial interior refrigerator-article such as antimicrobial refrigerator shelves, which avoid the disadvantages of the state of the art, especially the interior refrigerator-article should be easy to produce and furthermore have a high resistance against abrasion of the antimicrobial coating.

This aspect of the invention is solved by an interior refrigerator article comprising a glass article, wherein said glass article comprises anantimicrobial surface region, wherein said antimicrobial surface region is provided by an antimicrobial effective amount of metal ions in the surface region.

Preferably the interior refrigerator article is a refrigerator shelving.

The invention can be further on applied in the following fields if a glass substrate or a glass ceramic substrate has a antimicrobial glass surface: food contact, food display, food production, cook tops hospital equipment, medical devices, water treatment, water storage, water conducting, health care, hygiene products, white goods, kitchen and bathroom ware, table ware. The invention can also be applied in the field of dental products e. g. for providing antimicrobial dental products.

### Examples for Practicing the Invention

The following examples are illustrative of the invention and are intended to give those of ordinary skill in the art a more complete understanding of how the present process and articles of manufacture are to be achieved and evaluated. The examples are intended to be purely exemplary of the invention and are not intended to limit the scope of what the inventors regard as their invention. Efforts have been made to ensure accuracy with respect to numbers (e. g., amounts, temperatures, etc.), but some errors and deviations should be accounted for. Unless indicated otherwise, parts or percentages are parts or percentages by weight, temperature is in ° C. or is ambient temperature, and pressure is at or near atmospheric.

Antimicrobial testing was done according to the standard Tests ASTM 2180-01 with following microorganisms: Pseudomonas, aeruginosa, Staphylococcus aureus, Aspergillus, niger, Candida albicans, Echerichia Coli, und Salmonella choleraesius.

Antimicrobial testing according JIS Z2801 was done with Echerichia Coli and P. aeruginosa.

Tests were stated as “passes” if an microbial reduction of two log scales was detected.

Further on an antimicrobial testing was done by the Proliferation method which is described in Bechert et al., Nature Medicine Vol. 6 2000 1053-1056.

In this test the surface proliferation of microorganisms is detected by measuring the optical density of a solution which is in contact with the surface which has to be tested. The Proliferation test was done in all cases with S. epidermis. The Proliferation test was stated as passed if the measurement of optical density showed a retardation the increase in optical density.

### Examples for Treating a Substrate with a Suspension or a Solution

In a first example a soda-lime float glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 are coated by screening standard technology with a metal-ion precursor having oil as a vehicle and 1 weight-% of AgNO₃ as a metal ion. The film thickness was between 10-20 um.

The coated substrate was set into a furnace at first temperature of 550° C. for 10 minutes. The samples was cleaned with rinsing water for 1 minute. No significant discoloration of the glass samples was detected.

Then the ASTM 2180-01 Test and JIS Z2801 test was performed and passed.

In a further example a soda-lime float glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 are coated by screening standard technology with a metal-ion precursor having oil as a vehicle and 2 weight-% of AgNO₃ as a metal ion. The film thickness was about 15 um.

The coated substrate was set into a furnace at first temperature of 650° C. for 10 minutes. The samples was cleaned with rinsing water for 1 minute. Strong yellow discoloration of the glass samples was detected.

Then the ASTM 2180-01 Test and JIS Z2801 test was performed and passed.

In a further example a Ceriumoxid polished soda-lime float glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 are coated by screening standard technology with a metal-ion precursor having oil as a vehicle and 2 weight-% of AgNO₃ as a metal ion. The film thickness was about 40 um.

The coated substrate was set into a furnace at first temperature of 650° C. for 10 minutes. The samples was cleaned with rinsing water for 1 minute. No yellow discoloration of the glass samples was detected.

For the aforementioned example a EDX profile measurement was done to determine the silver penetration: The following are the values in weight-% found by EDX-measurement in dependency from the depth: 1um 0,3 wt %; 3 um 0,4 wt %; 5 um 0,4 wt %; 7um 0,3 wt %; 9 um 0,3 wt %; 11um 0,2 wt %; 13 um 0,3 wt % 15 um 0,2 wt % 17um 0,1 wt %, 19um 0,1 wt %; 21 um lower than detection lever 0, wt %

The error of the measurement is in the range of 0,1 wt %

Then the ASTM 2180-01 Test and JIS Z2801 test was performed and passed.

In a still further example a soda-lime glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 was polished on the atmosphere side (removal of about 1 um) and then coated by screening standard technology with a metal-ion precursor having oil as a vehicle and 1 weight-% of AgNO₃ as a metal ion. The film thickness was about 15 μm.

The coated substrate were set into a furnace at a first temperature of 650° C. for 10 minutes. The samples was cleaned with rinsing water for 1 minute. No significant discoloration of the glass samples was detected.

Then the ASTM 2180-01 Test and JIS Z2801 test was performed and passed.

In a even further example a soda-lime glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 are coated with a metal-ion precursor having oil as a vehicle and 2 weight-% of AgNO₃ as a metal ion after being cleaned with a 5-weight% HF-solution for 5 minutes and a Ultrasonic treatment.

The coated substrate was set into a furnace at a first temperature of 650° C. for 10 minutes and rapidly cooled down by air cooling. The samples were cleaned with water for 1 minute. No discoloration of the glass samples was detected.

Then the ASTM 2180-01 Test and JIS Z2801 test was performed and passed. The glass was significant mechanical strengthened.

In a further example a soda-lime glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 are coated with a metal-ion precursor having oil as a vehicle and 2 weight-% of AgNO₃ as a metal ion after being cleaned with 5% HNO₃ -solution for 20 minutes and a Ultrasonic treatment followed by 10% NaOH solution for 10 minutes.

The coated substrate was set into a furnace at a first temperature of 550° C. for 10 minutes and rapidly cooled down by air cooling. The samples was cleaned with water for 1 minute. No discoloration of the glass samples was detected.

Then the ASTM 2180-01 Test and JIS Z2801 test was performed and passed.

As a comparison a soda lime glass having the following composition in weight-% with a T(g) of 565° C. according to embodiment 1 of table 3 with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

was treated at only 150° C. 10 minutes and cleaned with water for 1 minute. The sample did not pass ASTM 2180-01 and JIS Z2801-Test and therefore showed no sufficient antimicrobial effect. This shows that a sufficient temperature is necessary to obtain a glass surface with a sufficient antimicrobial effect.

In a further example a soda-lime glass having the following composition in weight-% with regard to the total composition:

| | |
|---|---|
| Si0₂ | 72.00 weight-% |
| Al₂O₃ | 0.30 weight-% |
| Na₂O | 14.50 weight-% |
| MgO | 2.80 weight-% |
| CaO | 10.40 weight-% |

with a T(g) of 565° C. according to embodiment 1 of table 3 was surface polished on the atmosphere side and coated by screening standard technology with a metal-ion precursor having oil as a vehicle and 1 weight-% of AgNO₃ as a metal ion. The film thickness was about 15 um. The glass sheet was dried in an IR-furnace for 15 minutes. In a next step inorganic decoration paste was screen printed on the tin bath side of the flat glass and also dried in an IR-furnace for 15 min. Then the coated substrate was set into a furnace at a first temperature of 650° C. for 10 minutes and cooled down by air blowing rapidly. The samples was cleaned with rinsing water for 1 minute. No yellow discoloration of the glass samples was detected. The ASTM 2180-1 Test and the Proliferation Test was passed. The mechanical strength was according the requirements for window glass and glass shelves.

In an further example of the invention for which the results are shown in table 1 silver nitrate was added to Oil Ferro C38 as a vehicle to obtain the metal-ion precursor in a concentration as mentioned in Table 1 in the column “Ag-conc in solution”. The metal ion precursor material as a solution was screen printed on a float glass surface with a glass composition given in table 3, embodiment 1. The film thickness was about 10 μm. The samples then were dried in a first process step at 80° C. for 30 minutes. Thereafter the samples were introduced to a lab furnace. In the lab furnace the coated and dried glass-substrates were tempered at a second process-temperature given in Table 1 in column “Temp/Time” for the time in minutes and the temperature in ° C. Then they were removed out of the furnace and cooled in air.

The results are shown in Table 1. In Table 1 is also shown the average concentration of silver ions down to a depth of 2um of the substrate which was measured in an Surface Electron Microscope with EDX-Analysis.

TABLE 1
Soda Lime Float Glass (Type: Example 1 in table 3)

| | | | Ag surf. | | | | |
|---|---|---|---|---|---|---|---|
| | | | conc | | | | |
| | | | Coverge | | ASTM | Proliferation | JIS |
| Ag-conc in | | | of the | discoloration | 2180 | Test | Z 2801 |
| solution | Temp/Time | | first 2 μm | (b < 4) | passed | passed | passed |
| 0.5 | 400//10 | min | | No | | Yes | |
| 0.5 | 450//10 | min | | No | | Yes | |
| 0.5 | 650//10 | min | | No | | Yes | |
| 0.6 | 490//10 | min | 0.9 | No | | | yes |
| 0.6 | 550//10 | min | 0.5 | No | | | yes |
| 0.6 | 650//10 | min | 0.3 | | | | |
| 0.6 | 740//10 | min | 0.2 | | | | |
| 0.6 | 650//10 | min | 0.5 | No | no | | no |
| 0.6 | 100° C.//10 | min | <0.1 | No | No | | No |
| 1 | 480//10 | min | | No | | Yes | |
| 1 | 550//10 | min | | No | | | |
| 1 | 550//30 | min | | No | | | |
| 1 | 650//10 | min | | Yes | | | |
| 1 | 740//10 | min | | Yes | No | | |
| 2.0 | 350//30 | min | | No | | Yes | |
| 2.0 | 450//30 | min | | No | | Yes | |
| 2.0 | 500//30 | min | | No | Yes | | |
| 2.0 | 550//10 | min | 1.8 | No | Yes | | |
| 2.0 | 650//10 | min | 1.1 | Yes | yes | | yes |
| 2.0 | 650//10 | min | 1.3 | | | | |
| 2.0 | 650//20 | min | 0.6 | Yes | no | | no |
| 2.0 | 740//10 | min | 0.8 | Yes | | | |
| 4.0 | 400//30 | min | | No | Yes | Yes | |
| 4.0 | 550//10 | min | 3.6 | No | Yes | | |
| 4 | 650//10 | min | 2.4 | Yes | Yes | | |
| 4 | 740//10 | min | 1.9 | Yes | Yes | | |

As is apparent from table 1 the antimicrobial efficacy crucial depends on the silver ions concentration at the surface of the glass or the concentration of ions which can reach the surface e.g. by diffusion processes during the application. This “active” silver concentration depends on the following processing parameters:
Silver precursor concentration in the solution;
thickness of the solution film on the glass substrate,
Temperature/Time regime of the whole processing.

The temperature/time regime is very important because if temperature and time are too low not enough antimicrobial ions can bond to or introduce into the surface of the substrate and are washed off the substrate by simple cleaning processes. If temperature and time are too high, the antimicrobial ions will penetrate too deep into the glass and are no longer active in a sufficient amount at the surface in the application. In specific cases the surface might be tempered several times because of production reasons (e. g. a further tempering step to burn in a color or decoration layer). In such a case the overall integral temperature/time process has to be taken into account.

In a further example a concentration of 0,6 weight-% AgNO₃ and 2 weight-% ZnNO₃ was dispersed in C38 Oil as a vehicle for the metal ion precursor with a mixer. The metal ion precursor as a solution was then screen printed on the air side of the float glass with a thickness of the layer of approx. 10 μm The float glass is also a Soda-lime glass with a composition according to embodiment 1 in table 3.

For different samples of soda lime-glass substrates, all of them comprising the glass composition according to embodiment 1 of table 3, which were treated with a metal-ion precursor material consisting of C38 Oil as a vehicle and different concentrations of AgNO₃ as metal ions and thereafter temperature-treated in a furnace at 650° C. for different temper times e. g.15 min and than again removed and cooled in air, the silver concentration profile over the depth of the substrate was measured. The results are shown in Table 2.

TABLE 2
SEM-EDX Analysis to evaluate the silver concentration profile over the
depth of the substrate dependent from tempering time

| | AgNO3 | | | | | | | | |
|---|---|---|---|---|---|---|---|---|---|
| | conc. | | | | | | | | |
| | of the | | | | | | | | |
| ASTM- | metal ion | | | | | | | | |
| test | precursor | temperature | Depth | | | | | | |
| AM- | in | (° C.) | surface | Depth | Depth | Depth | Depth | Depth | Depth |
| effect | weight-% | time (min) | (0 μm) | 1 um | 2 um | 3 um | 4 um | 5 um | 10 μm |
| No | 0.6% | 650//15 min | 0.5 | 0.5 | 0.6 | 0.1 | 0 | 0 | 0 |
| yes | 4% | 650//15 min | 1.1 | 1.1 | 0.7 | 0.2 | 0.2 | 0 | 0 |
| No | 0.6 | 650//15 min | 0.5 | 0.4 | 0.2 | 0.1 | 0 | 0 | 0 |
| | 2% | 650//15 min | 1.3 | | | | | | 0 |
| | 4% | 650//15 min | 2.4 | | | | | | 0 |
| | 0.6 | 650//10 min | 0.3 | | | | | | 0 |
| no | 0.6 | 680//10 min | 0.2 | 0.2 | 0.3 | 0 | 0 | 0 | 0 |
| yes | 2 | 680//10 min | 0.8 | 0.7 | 0.2 | 0.2 | 0 | 0 | 0 |

As is apparent from Table 2 an antimicrobial effect or a so called AM-effect according to the experiments shown in table 2 for a surface concentration of about 0,8 wt % is sufficient to pass. This means, the parameters for the temper temperature, the duration of tempering as well as the concentration of Ag-ions in the precursor material have to be chosen according to the invention such, that a surface concentration of Ag-ions of more than 0,8 weight-% results.

Then a antimicrobial effect, which is sufficient to pass the ASTM-test is achieved. As is apparent from table 1 a surface concentration greater than 0,8 weight-% is necessary for an antimicrobial effect, to pass the ASTM-Test. The surface concentration in table 1 is the average of the silver ion concentration in the first 2 μm.

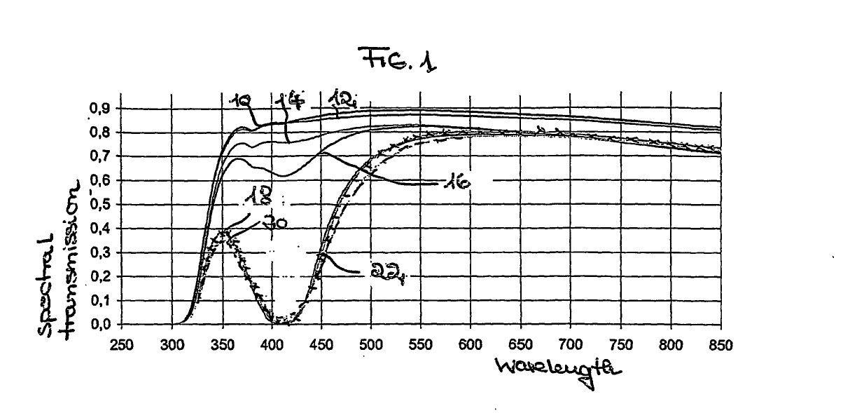

FIG. 1 shows the transmission spectra of float glass samples which were tempered at different temperatures between 550 and 740° C. The composition of the float glass was according to embodiment 1 in Table 3. The concentration was 4 weight-% AgNO₃ in the metal-ion precursor-solution. The samples were introduced into a furnance at different temperatures for 10 minutes, removed again and cooled down in air. Reference number 10 denotes a temperature of 500° C., 14 denotes a temperature of 600° C., 16 denotes a temperature of 650° C., 18 denotes a temperature of 680° C., 20 denotes a temperature of 700° C. and 22 denotes a temperature of 750° C. As is apparent from FIG. 1 the higher the temperature for tempering the more a significant absorption bands can be seen which are caused by the absorption of silver nanoparticles.

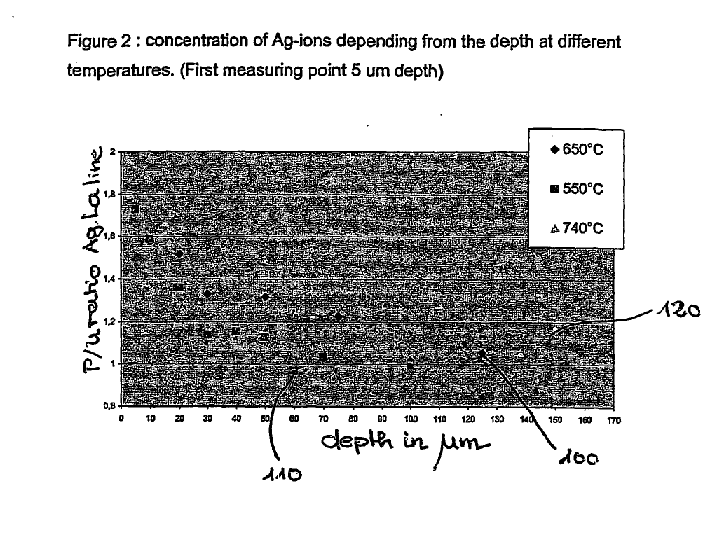

In FIG. 2 is shown the concentration-profile of Ag-ions implanted into the surface of the substrate by the inventive technique depending onto the temper-temperature of the substrate. This measurement was done by EDX-Analysis. The first measuring point was taken at a depth of about 5 um from the glass surface. Ag concentration is plotted in arbitrary units. As can be seen from FIG. 2, the Ag-ions are penetrating the glass deeper with increasing temperature. Points 100 denotes a sample which was tempered with 650° C. points 110 denotes a sample which was tempered with 550° C. and points 120 denotes a sample which was tempered with 740° C.

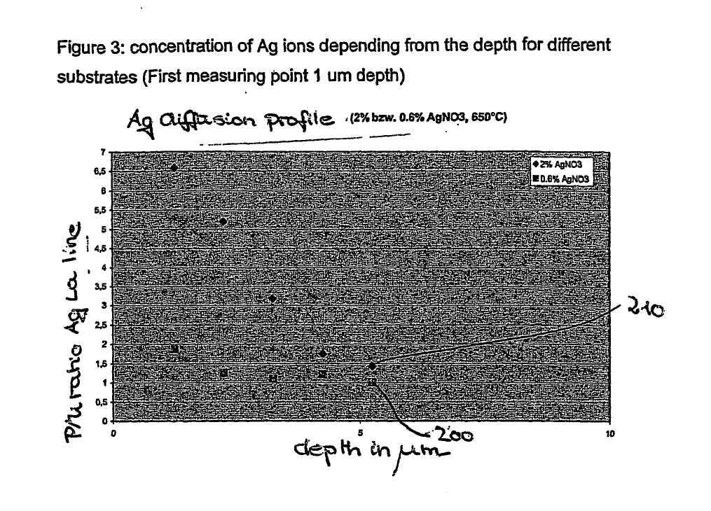

FIG. 3 of the same sample as in FIG. 2 shows the silver concentration in the first 5 um depth measured with WDX-Analysis. The WDX-Analysis has a higher spatial resolution than EDX-Analysis. The Ag diffusion in a bulk surface for 2 samples is shown. The first sample was a sample of a glass substrate coated with a metal-ion precursor-solution having a content of 0,6 weight-% AgNO₃. The points for sample 1 is denoted with 200. Sample 2 was coated with a metal-ion-precursor solution having a content of 2 weight-% AgNO₃. The points for sample 2 is denoted with 210. Both samples were tempered at 650° C. for 15 min. As is apparent from FIG. 3 the silver surface concentration is about 3 times higher for the sample produced from the metal ion precursor solution having 2 weight-% AgNO₃ than from the metal ion precursor solution having 0,6 weight-% AgNO₃. The glass-substrates for both samples are soda lime glass substrates with a composition according to table 3, embodiment 1. The significant difference in there near surface concentration of silver can be seen.

As is apparent from the foregoing paragraph the Ag-concentration to pass the ASTM test should be higher than about 0,8 weigh-t % Ag at the surface. This is measured preferably by EDX with a information depth of about 2 μm.

The silver salt concentration of the solutions is limited by the solubility of the silver salt. If the concentration is in the range of the solubility silver salt particles can be detected by SEM on the flat glass surfaces. E. g. in oil C38 the solubility limit of AgNO₃ is around 3 weight-%. Tempering should be done in oxidizing conditions to avoid reduction of silver.

To determine the ion-release out of the glass substrate with an antimicrobial surface provided by the process described above, the glass substrates were treated with a aqueous solution comprising 3 weight-% acetetic acid for 10 days and a temperature of 40° C. The release surface was 100cm².

As is apparent from the forgoing the release of Ag is lower than 0,08 mg/l, the value allowed according to the German law related to drinking water (so called Trinkwasserverordnung).

In FIG. 4 TOF-SIMS measurement of an untreated soda lime float glass surface (atmosphere side) according to example 1 in table 3 is shown.

An increase of the tin concentration (Sn-concentration) at the surface can be seen. The curve for the tin-concentration is denoted with reference number 300.

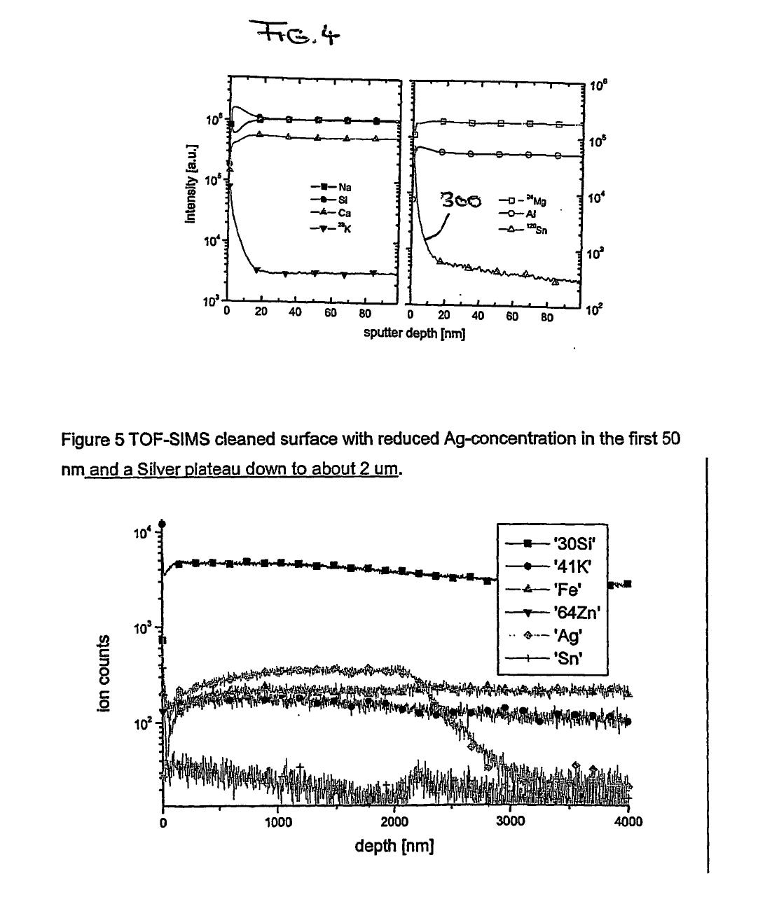

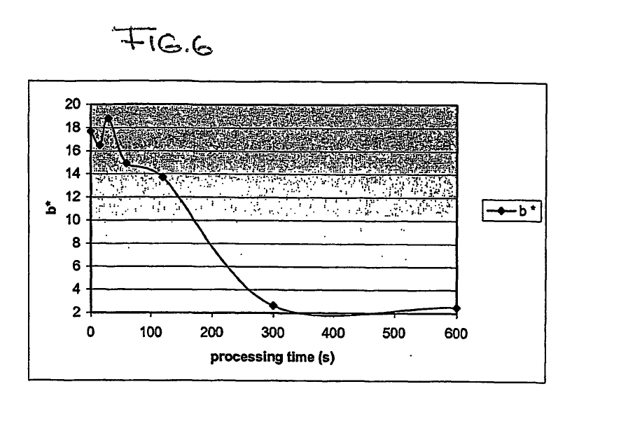

FIG. 5 shows an TOF-SIMS measurement of an example with reduced Ag-concentration in the first 50 nm and a Silver plateau down to about 2 um. Samples is according Table 1 with a Ag-concentration in solution of 2 weight-%, a temper-temperature of 650 ° C. and a temper time of 10 min.

FIG. 6 shows the reduction of Yellowing of soda lime glass due to chemical etching. Soda lime Float glass was pretreated with in a 4% HF solution in a ultrasonic bath for different times and treated with a 2% solution of AgNO₃. The samples introduced in a furnace for 10min at about 650° C. The color index b* is the index for yellow color and therefore for the yellowing.

In the following table 3 further composition of glasses are given, which can be used to practice the invention:

TABLE 3
Glass composition for various embodiments (Emb.) of the invention in
weight-% on basis of an oxide

| | | | | | | | | | | Emb. | Emb. | Emb. |
|---|---|---|---|---|---|---|---|---|---|---|---|---|
| | Emb. 1 | Emb. 2 | Emb. 3 | Emb. 4 | Emb. 5 | Emb. 6 | Emb. 7 | Emb. 8 | Emb. 9 | 10 | 11 | 12 |
| SiO₂ | 72.00 | 73.50 | 64.10 | 80.80 | 69.90 | 79.00 | 50.40 | 61.20 | 76.50 | 64.30 | 71.20 | 69.10 |
| B₂O₃ | | 10.00 | 8.40 | 12.70 | 11.20 | 10.40 | 13.40 | 7.90 | 5.00 | | | 1.00 |
| Al₂O₃ | 0.30 | 6.70 | 4.20 | 2.40 | | 4.20 | 11.80 | 16.30 | 3.40 | 21.50 | 0.35 | 4.00 |
| Li₂O | | | | | | | | | | 3.65 | | |
| Na₂O | 14.50 | 6.60 | 6.40 | 3.50 | 9.70 | 4.60 | 0.10 | | 8.10 | 0.70 | 14.10 | 12.70 |
| K₂O | | 2.60 | 6.90 | 0.60 | 7.30 | 0.80 | | | | | | 3.30 |
| MgO | 2.80 | | | | | | | 2.80 | | | 4.00 | 2.70 |
| CaO | 10.40 | 0.60 | | | 0.25 | 1.00 | | 8.30 | | | 9.60 | 5.00 |
| SrO | | | | | | | 0.30 | | | | | |
| BaO | | | | | 1.50 | | 24.00 | 3.50 | 5.00 | 2.40 | | 2.20 |
| ZnO | | | 6.00 | | | | | | | 1.20 | | |
| TiO₂ | | | 4.00 | | 0.15 | | | | | 2.30 | | |
| ZrO₂ | | | | | | | | | | 1.60 | | |
| Sb₂O₃ | | | | | | | | | | 1.50 | | |
| Fe₂O₃ | | | | | | | | | | 0.15 | 0.10 | |
| CoO | | | | | | | | | | 0.30 | | |
| NlO | | | | | | | | | | 0.40 | | |
| F | | | | | | | | | 2.00 | | | |
| α | 5.40 | 5.40 | 7.20 | 3.30 | 8.30 | 4.05 | 4.54 | 3.77 | 5.60 | 4.20 | | |
| T_{g} | 565 | 565 | 557 | 525 | 559 | 580 | 627 | 716 | 550 | 673 | | 530 |
| VA | 1189 | 1189 | 1051 | 1270 | 968 | 1280 | 1215 | 1263 | | 1305 | | 1040 |
| Temperature | 350.0 | 600.00 | 600.00 | 520.00 | 650.00 | 620.00 | 550.00 | 800.00 | 650.00 | 720.00 | 650 | 610 |
| Time | 30 min | 3 min | 5 min | 3 min | 10 min | 10 min | 10 min | 10 min | 10 min | 15 min | 10 min | 10 min |
| Solution | water | Water | Water | C38 Oil | Water | Water | C38 Oil | C38 Oil | C38 Oil | C38 Oil | C38 Oil | C38 Oil |
| Conc Ag | 2% | 2% | 1% | 2% | 2% | 2% | 2% | 1% | 1% | 1% | 1% | 1% |
| | Nitrate | Nitrate | Nitrate | Nitrate | Nitrate | Nirate | Nitrate | Nitrate | Nitrate | Nitrate | Nitrate | Nitrate |
| Conc Zn | | | 1% | | | | | | | | | |
| | | | Nitrate | | | | | | | | | |
| Conc Cu | | | 0.2% | | | | | 0.2% | | | | |
| | | | Sulfate | | | | | Sulfate | | | | |
| Proliferation | yes | yes | yes | yes | yes | yes | yes | yes | yes | yes | yes | yes |
| passed | | | | | | | | | | | | |
| Summe | 100.00 | 100.00 | 100.00 | 100.00 | 100.00 | 100.00 | 100.00 | 100.00 | 100.00 | 100.00 | | |

In table 3 T(g) denotes the transformation temperature of glass and V_{A} the processing temperature.

Embodiment 1 in table 1 corresponds to a soda lime glass described in the examples before. Also for the other glasses an antimicrobial effect and a concentration profile could be shown.

Furthermore for the different glasses the treatment with a solution containing metal ions is given.

In table 3 solution describes the solution applied onto the glass surface, e. g. C38 oil describes a C38 oil solution. The concentration of Ag, Cu, Zn-ions in this solution is given by conc Ag, conc Cu, conc Zn in weight-%.

Temperature denotes the temperature the glass substrate on which the solution was applied was heated in a furnance. Time denotes how long the substrate was heated in a furnance to the temperature given before.

For example from table 3 one can read, that for a glass of embodiment 7 with a solution of C38 oil containing 2 weight-% AgNo₃ after a treatment for 10 minutes with a temperature of 550° C. the antimicrobial proliferation test was passed.

In a further example an alkaline free glass according to embodiment 8 in table 3 was screen printed with C38 oil with 2 wt % AgNO₃. The sample was introduced into a furnace at 800° C. for 20 minutes and afterwards cooled down in air. The samples passed the antimicrobial proliferation test and the JIS Z2080 test.

In table 4 for glasses according to embodiment 2, 3, 4, 5, 6, 7, 8 and 9 the results after screen-printing a glass substrate with a solution containing a certain amount of metal ions given in table 3 for a temperature and a time given in table 3 are shown.

After the glasses were coated with the metal-ion containing solution and heated for the time given in table 3, the glass substrate was cooled down in air. As is apparent from table 3 for different glass types given in table 3, especially for glass types containing a small amount of alkali-ions (embodiment 8) a antimicrobial effect could be observed. This could be concluded form the fact, that all glasses passed the antimicrobial proliferation test, the ASTM-test and the JISZ2080 test.

Furthermore for all glasses shown in table 3 the concentration profile of Ag-ions in weight-% is given in table 4:

TABLE 4
ASTM-test-results and silver concentration profile over the depth of the
substrate of different glasses after treatment according to table 3

| glass-type | | Depth | Depth | Depth | Depth | Depth | Depth | Depth |
|---|---|---|---|---|---|---|---|---|
| according | ASTM- | surface | 1 um | 2 um | 3 um | 4 um | 5 um | 10 μm |
| to | test | (weight- | weight- | weight- | weight- | weight- | weight- | weight-% |
| table 3 | AM-effect | % Ag) | % Ag | % Ag | % Ag | % Ag | % Ag | Ag |
| Emb 2 | yes | 1.3 | 1.5 | 1.1 | 0.3 | | 0 | 0 |
| Emb 3 | Yes | 1.1 | 1.2 | 1.2 | 0.7 | 0.3 | 0 | 0 |
| Emb 4 | Yes | 1.1 | 1.1 | 0.5 | 0 | 0 | 0 | 0 |
| Emb 5 | Yes | 2.4 | 2.7 | 2.3 | 1.9 | 0.6 | 0.2 | 0.1 |
| Emb 6 | Yes | 1.4 | 1.5 | 1.3 | 0.9 | 0.4 | 0 | 0 |
| Emb 7 | Yes | | 1.0 | 0.4 | 0.1 | | 0 | 0 |
| Emb 8 | Yes | | 2.2 | 1.9 | 0.9 | 0.5 | 0 | 0 |
| Emb 9 | Yes | 2.9 | 3.2 | 2.9 | 2.7 | 2.1 | 1.5 | 0.2 |

From table 4 it is apparent, that all glasses contain a silver ion profile. The amount of silver ions is decreasing form the surface into the depth of the substrate. Also glass-ceramics could be treated with metal-ion containing solutions or suspensions. Examples for glass-ceramics are given in the following patent applications: EP 1 170 264, DE 100 17 701, EP 0 220 333. The content of these applications is incorporated to the full extent in this application. According to EP 1 170 264 the green glass of the glass-ceramic comprises a composition as given in table 5:

TABLE 5
Composition of a first embodiment of a green glass for a glass-ceramic

| | |
|---|---|
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-2.5 |
| Σ CaO + SrO + BaO | 0.2-3.0 |
| ZnO | 1.0-2.2 |
| Al₂O₃ | >19.8-23.0 |
| SiO₂ | 66-70 |
| TiO₂ | 2.0-3.0 |
| P₂O₅ | 0-1.0 |

as well as a refining agent e.g. As₂O₃, Sb₂O₃, SnO₂, CeO₂ and/or sulfat/chloride compounds in usual amounts.

Preferred compositions green glass for glass-ceramics according to table 5 are given in table 6.

TABLE 6
Preferred compositions of green glasses of table 5

| | embodiment GK1 | embodiment GK2 |
|---|---|---|
| Li₂O | 3.5 | 3.5 |
| Na₂O | 0.2 | 0.15 |
| K₂O | 0.2 | 0.2 |
| MgO | 1.2 | 1.15 |
| BaO | 1.0 | 0.8 |
| ZnO | 1.7 | 1.5 |
| Al₂O₃ | 20.2 | 20.0 |
| SiO₂ | 66.9 | 67.2 |
| TiO₂ | 2.7 | 2.6 |
| ZrO₂ | 1.7 | 1.7 |
| As₂O₃ | 0.7 | 1.2 |
| Summe | 100.0 | 100.0 |

For embodiment GK1 of table 6 different temper-temperatures and temper-times for obtaining a glass ceramic out of the green glass are given in table 7.

TABLE 7
Temper-temperatures and temper-times to obtain a glass ceramic
out of a green glass according to embodiment GK1 in table 6:

| | embodiment | | | | | | | | |
|---|---|---|---|---|---|---|---|---|---|
| | GK1 | GK1 | GK1 | GK1 | GK1 | GK1 | GK1 | GK1 | GK1 |
| temper- | 1040 | 1040 | 1050 | 1050 | 1050 | 1060 | 1060 | 1070 | 1070 |
| temper- | | | | | | | | | |
| ature | | | | | | | | | |
| Tₘₐₓ | | | | | | | | | |
| (° C.) | | | | | | | | | |
| temper- | 30 | 60 | 18 | 24 | 35 | 18 | 24 | 12 | 18 |
| time | | | | | | | | | |
| (min) | | | | | | | | | |

In table 8 an example for a green glass used for obtaining a glass-ceramic as described in EP 0220333 is given.

TABLE 8
Composition of a green-glass in weight-% of oxide

| | |
|---|---|
| SiO₂ | 62-68 |
| Al₂O₃ | 19.5-22.5 |
| Li₂O | 3.0-4.0 |
| Na₂O | 0-1.0 |
| K₂O | 0-1.0 |
| BaO | 1.5-3.5 |
| CaO | 0-1.0 |
| MgO | 0-0.5 |
| ZnO | 0.5-2.5 |
| TiO₂ | 1.5-5.0 |
| ZrO₂ | 0-3.0 |
| MnO₂ | 0-0.40 |
| Fe₂O₃ | 0-0.20 |
| CoO | 0-0.30 |
| NiO | 0-0.30 |
| V₂O₅ | 0-0.80 |
| Cr₂O₃ | 0-0.20 |
| F | 0-0.20 |
| Sb₂O₃ | 0-2.0 |
| As₂O₃ | 0-2.0 |
| ΣNa₂O + K₂O | 0.5-1.5 |
| ΣBaO + CaO | 1.5-4.0 |
| ΣTiO₂ + ZrO₂ | 3.5-5.5 |
| ΣSb₂O₃ + As₂O₃ | 0.5-2.5 |

In table 9 various examples of green glass composition according table 8 are shown.

TABLE 9
Examples for green glass compositions according to table 8
(in weight-% on basis of oxide)

| | 1 | 2 | 3 | 4 | 5 | 6 | 7 | 8 |
|---|---|---|---|---|---|---|---|---|
| SiO₂ | 64.00 | 67.80 | 64.50 | 65.20 | 65.40 | 64.90 | 65.30 | 65.00 |
| Al₂O₃ | 21.30 | 20.10 | 21.40 | 21.20 | 21.10 | 21.80 | 21.20 | 21.40 |
| Li₂O | 3.50 | 3.35 | 3.60 | 3.70 | 3.50 | 3.50 | 3.70 | 3.60 |
| Na₂O | 0.60 | 0.30 | 0.60 | 0.60 | 0.80 | 0.75 | 0.60 | 0.70 |
| K₂O | 0.50 | 0.20 | 0.15 | 0.20 | 0.25 | 0.05 | 0.20 | 0.25 |
| BaO | 2.50 | — | 2.30 | 2.30 | 2.35 | 2.40 | 2.30 | 2.35 |
| MgO | — | 1.58 | — | — | — | — | — | — |
| ZnO | 1.50 | 1.30 | 1.20 | 1.50 | 1.30 | 1.20 | 1.45 | 1.30 |
| TiO₂ | 2.30 | 4.90 | 2.30 | 2.30 | 2.25 | 2.40 | 2.30 | 2.20 |
| ZrO₂ | 1.60 | — | 1.60 | 1.45 | 1.58 | 1.60 | 1.45 | 1.60 |
| MnO₂ | 0.65 | — | 0.17 | 0.15 | 0.08 | 0.08 | 0.03 | — |
| Fe₂O₃ | 0.23 | 0.03 | 0.18 | 0.09 | 0.04 | 0.06 | 0.05 | 0.03 |
| CoO | 0.37 | — | 0.23 | 0.12 | 0.07 | 0.07 | 0.05 | — |
| NiO | 0.06 | — | 0.29 | 0.15 | 0.10 | 0.09 | 0.04 | — |
| V₂O₅ | — | 0.10 | — | 0.15 | 0.45 | 0.25 | 0.30 | 0.40 |
| Sb₂O₃ | 0.85 | — | 1.50 | 1.00 | 1.00 | 1.10 | 1.00 | 1.20 |
| As₂O₃ | — | 0.36 | — | — | — | — | — | — |

In DE 10017701 the composition given in table 10 of a green glass for a glass-ceramic is shown.

TABLE 10
Composition of a green glass for a glass-ceramic (in weight-% on basis
of oxide)

| | |
|---|---|
| Li₂O | 3.2-5.0 |
| Na₂O | 0-1.5 |
| K₂O | 0-1.5 |
| ΣNa₂O + K₂O | 0.2-2.0 |
| MgO | 0.1-2.2 |
| CaO | 0-1.5 |
| SrO | 0-1.5 |
| BaO | 0-2.5 |
| ZnO | 0-<1.5 |
| Al₂O₃ | 19-25 |
| SiO₂ | 55-69 |
| TiO₂ | 1.0-5.0 |
| ZrO₂ | 1.0-2.5 |
| SnO₂ | 0-<1.0 |
| ΣTiO₂ + ZrO₂ + SnO₂ | 2.5-5.0 |
| P₂O₅ | 0-3.0 |

In table 11 examples of green glasses of a composition as shown in table 10 and their tempering-temperatures and tempering-conditions to obtain a glass-ceramic starting from the green glass composition given:

TABLE 11
Examples for glass ceramics out of green glasses compositions (in
weight-% on a oxide basis) according to table 10:

| | sample no. | | | | |
|---|---|---|---|---|---|
| | 1 | 2 | 3 | 4 | 5 |
| Li₂O | 4.1 | 4.17 | 3.85 | 3.8 | 3.6 |
| Na₂O | 0.4 | 0.37 | 0.56 | 0.7 | 0.2 |
| K₂O | 0.3 | 0.35 | — | — | 0.5 |
| MgO | 0.55 | 1.10 | 0.46 | 0.9 | 1.3 |
| CaO | — | — | — | 0.5 | 1.0 |
| BaO | — | — | 2.03 | 1.0 | — |
| ZnO | — | — | 1.40 | — | — |
| Al₂O₃ | 22.9 | 22.5 | 22.34 | 22.2 | 21.8 |
| SiO₂ | 66.1 | 65.82 | 65.1 | 65.5 | 66.3 |
| TiO₂ | 2.1 | 2.15 | 1.9 | 2.3 | 1.9 |
| ZrO₂ | 2.05 | 2.0 | 1.96 | 1.9 | 2.05 |
| SnO₂ | 0.15 | 0.24 | 0.4 | 0.2 | 0.15 |
| P₂O₅ | 1.35 | 1.3 | — | 1.0 | 1.2 |
| Σ | 100.0 | 100.0 | 100.0 | 100.0 | 100.0 |
| Tg (° C.) | 703 | 694 | 682 | 704 | 698 |
| V_{A} (° C.) | 1342 | 1334 | 1331 | 1331 | 1337 |
| α_{20/300} (10⁻⁶/K) | 4.0 | 4.1 | 4.1 | 4.2 | 4.0 |
| Lichttransmission | 90.5 | 91.4 | 89.9 | 87.9 | 90.1 |
| (%), 4 mm Dicke | | | | | |
| formation of | 755 | 755 | 760 | 750 | 750 |
| crystallites | | | | | |
| temperature (° C.) | | | | | |
| (min) | 60 | 60 | 60 | 60 | 60 |
| cristalization- | 916 | 903 | 896 | 909 | 910 |
| temperature (° C.) | | | | | |
| (min) | 15 | 15 | 15 | 15 | 15 |
| crystal phase | hQMK | HQMK | HQMK | hQMK | hQMK |
| cristallite size (nm) | 42 | 40 | 42 | 48 | 55 |
| | transparent | transparent | Transparent | transparent | transparent |
| α_{20/700} (10⁻⁸/K) | −0.34 | 0.03 | −0.20 | 0.31 | 0.47 |
| light-transmission | 84.7 | 84.8 | 80.6 | 83.0 | 83.9 |

In table 11 α denotes the thermal expansion coefficient, and hQMK a “Hochquarzmischkristall” also denoted as high quartz mixed crystal phase.

### Examples for Treating a Substrate in a Melt or with a Paste

Examples for obtaining a antimicrobial surface via an ion exchange process in a melt or a paste for a flat glass or a glass ceramic are given in the following paragraph.

In table 11 are shown examples for glass compositions which are provided with an antimicrobial surface via ion exchange or diffusion in a melt:

TABLE 12
Glass compositions which were provided with a antimicrobial surface layer via ion
exchange and/or diffusion in a melt (in weight % on a oxide basis:)

| | Embodiment M1 | Embodiment M2 |
|---|---|---|
| SiO₂ | 45 | 71.2 |
| Al₂O₃ | 0 | 0.35 |
| CaO | 25 | 9.6 |
| MgO | 0 | 4.0 |
| Fe₂O₃ | 0 | 0.1 |
| Na₂O | 25 | 14.1 |
| K₂O | | 0.05 |
| P₂O₅ | 5 | |

| | Emb | Emb | Emb | Emb | Emb | Emb | Emb | Emb | Emb |
|---|---|---|---|---|---|---|---|---|---|
| | M3 | M4 | M5 | M6 | M7 | M8 | M9 | M10 | M11 |
| SiO₂ | 73.50 | 64.10 | 80.80 | 69.90 | 79.00 | 50.40 | 61.20 | 76.50 | 64.30 |
| B₂O₃ | 10.00 | 8.40 | 12.70 | 11.20 | 10.40 | 13.40 | 7.90 | 5.00 | |
| Al₂O₃ | 6.70 | 4.20 | 2.40 | | 4.20 | 11.80 | 16.30 | 3.40 | 21.50 |
| Li₂O | | | | | | | | | 3.65 |
| Na₂O | 6.60 | 6.40 | 3.50 | 9.70 | 4.60 | 0.10 | | 8.10 | 0.70 |
| K₂O | 2.60 | 6.90 | 0.60 | 7.30 | 0.80 | | | | |
| MgO | | | | | | | 2.80 | | |
| CaO | 0.60 | | | 0.25 | 1.00 | | 8.30 | | |
| SrO | | | | | | 0.30 | | | |
| BaO | | | | 1.50 | | 24.00 | 3.50 | 5.00 | 2.40 |
| ZnO | | 6.00 | | | | | | | 1.20 |
| TiO₂ | | 4.0 | | 0.15 | | | | | 2.30 |
| ZrO₂ | | | | | | | | | 1.60 |
| Sb₂O₃ | | | | | | | | | 1.50 |
| Fe₂O₃ | | | | | | | | | 0.15 |
| CoO | | | | | | | | | 0.30 |
| NiO | | | | | | | | | 0.40 |
| F | | | | | | | | 2.00 | |
| Sum | 100.00 | 100.00 | 100.00 | 100.00 | 100.00 | 100.00 | 100.00 | 100.00 | 100.00 |

Embodiment M1 shows a soda lime glass in form of a flat glass-disk with the surface having a high ion release, i.e. a very reactive surface in watery medium.

The ion exchange for the glass-disk with the composition according to embodiment M1 was performed in a silver nitrate melt with a content of 100% silver nitrate. In table 13 are given the temperature T (° C.) as well as the times t (h) for which the exchange was performed as well as the concentration of Ag₂O in a depth of 0-2 μm as well as 2-4 μm of the substrate.

TABLE 13
Ag₂O concentration of ion exchanged glasses with regard to the depth

| | | | depth | |
|---|---|---|---|---|
| Glass type | (° C.) | t (h) | 0-2 μm | 2-4 μm (% m/m Ag₂O) |
| Emb. M1 | 240 | 1 | 27.0 | 11.7 |
| Emb. M1 | 240 | 2 | 30.7 | 31.9 |
| Emb. M1 | 240 | 4 | 35.9 | 35.9 |
| Emb. M1 | 260 | 2 | 34.9 | 32.9 |
| Emb. M1 | 295 | 1 | 36.6 | 39.9 |
| Emb. M1 | 295 | 2 | 42.0 | 41.8 |

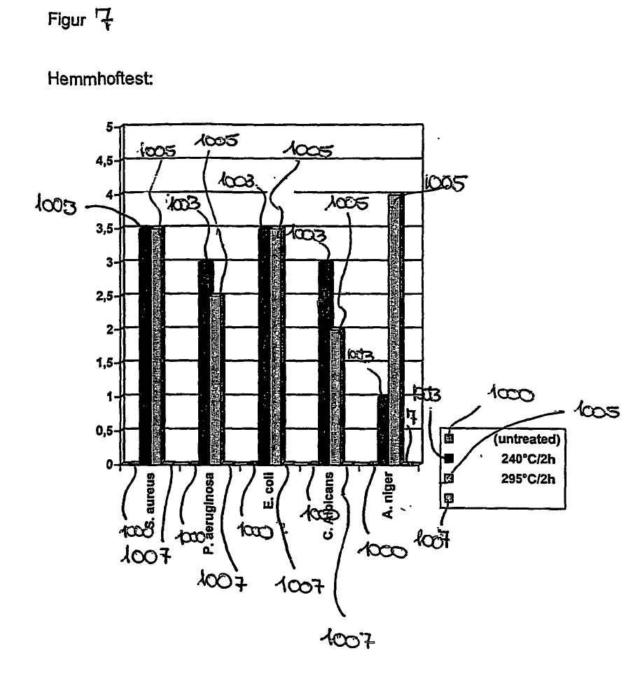

FIG. 7 shows the result of a Hemmhof-test for different sorts of bacteria. In FIG. 7 1000 denotes the untreated sample, 1003 denotes a sample for which at a temperature of 240° C. for two hours an ion exchange in a 100 weight % Ag-nitrate melt was performed, 1005 a sample for which at a temperature of 295° C. an ion exchange for two hours was performed and 1007 a control sample. As the Hemmhof-test shows Ag-ions diffuse from the reactive glass surface into the surrounding watery medium, such that in a distance to the antimicrobial glass surface an antimicrobial effect can be detected.

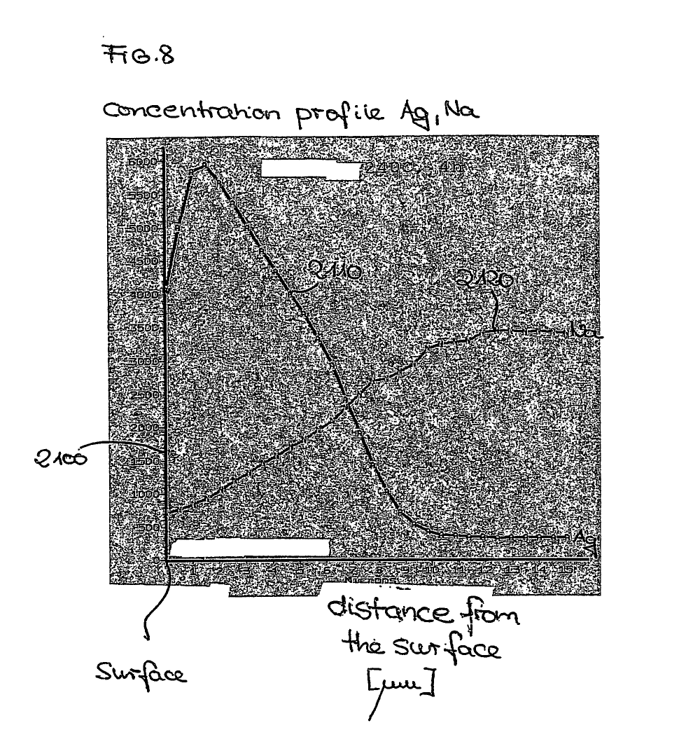

In FIG. 8 the concentration profile of Ag and Na with regard to the depth in μm of the substrate is shown. As is apparent from FIG. 8 Ag is enriched at the surface. The surface is denoted with 2100, the concentration of Ag is the reference number 2110 and the concentration of Na is reference number 2120. The profile was detected by an electron micro-probe. The sample which was examined in FIG. 8, was a soda lime glass according to embodiment M1. The soda lime glass was treated in an ion exchange process for 4 h at a temperature of 240° C. with a 100 weight % silver nitrate melt.

In an further embodiment of the invention a soda lime glass according to embodiment M2 in table 12 was examined. The soda lime glass according to embodiment M2 in table 12 has a very high chemical stability and a very low ion release rate in watery medium. In table 14 the concentration of Ag₂O in dependence from the exchange temperature T(° C.) and exchange time t (min) in a depth of 0-2 μm and in a depth of 2-4 μm is given. The glasses were treated in a 100 weight % silver nitrate melt for the given time t (h) and the given temperature T(° C.).

TABLE 14
Ag₂O concentration of ion exchanged glasses in a 100 weight % Ag
nitrate melt.

| Glass type | (° C.) | t (h) | 0-2 μm | 2-4 μm (% m/m Ag2O) |
|---|---|---|---|---|
| Emb. M2 | 240 | 1 | 14.4 | 1.9 |
| Emb. M2 | 240 | 2 | 18.8 | 11.2 |
| Emb. M2 | 240 | 4 | 23.2 | 16.7 |
| Emb. M2 | 260 | 2 | 22.1 | 18.5 |
| Emb. M2 | 295 | 1 | 22.9 | 21.1 |
| Emb. M2 | 295 | 2 | 19.9 | 25.4 |

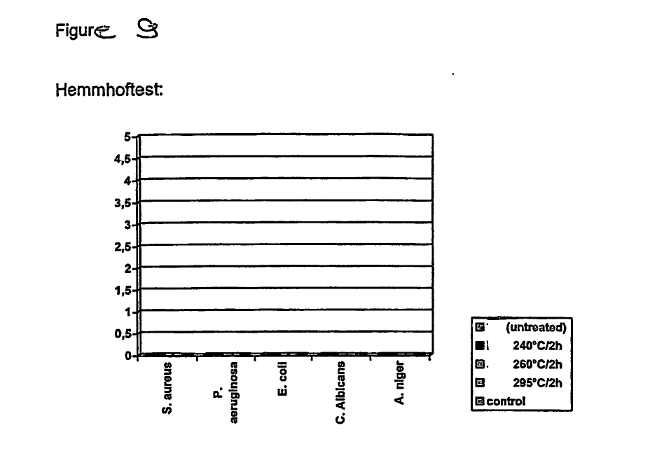

In FIG. 9 the Hemmhof-test is shown. As is apparent from FIG. 9 according to the high stability of the glass no biocide effect in a distance to the glass surface was found. The biocide effect or activity is solely restricted to the surface as the proliferation test shows.

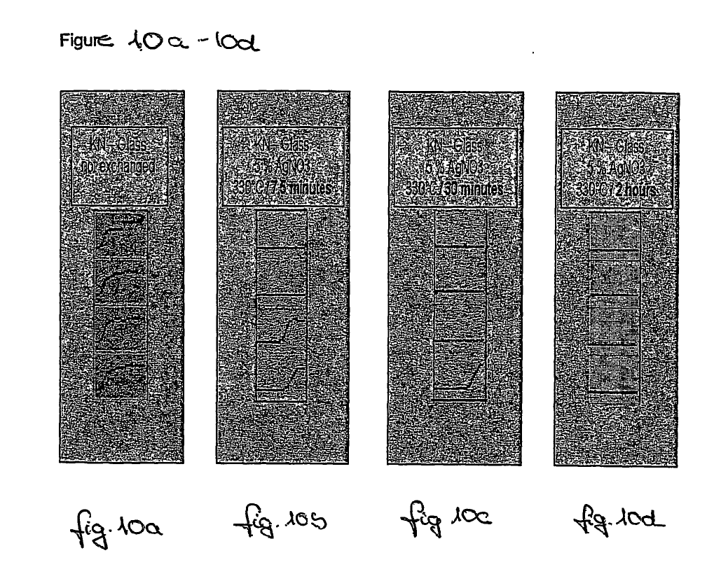

In FIG. 10a-10d the results of a proliferation test is shown. FIG. 10a shows the result for a untreated soda-lime glass. FIG. 10b-10d show the results for treated soda-lime glasses. The glasses were treated at 330° C. with a 5 weight % AgNO₃/ 95% NaNO₃ melt for 7,5 minutes (FIG. 10b), 30 minutes (FIG. 10c) and 2 hours (FIG. 10d). FIG. 10a shows a reference sample for which no ion exchange was performed. The figures show the optical density of the surrounding nutrient medium. An increase of the curve correlates to a germ growth. As is apparent, with an increasing exchange time a stronger biocide effect results. The biocide effect substantially occurs at the surface.

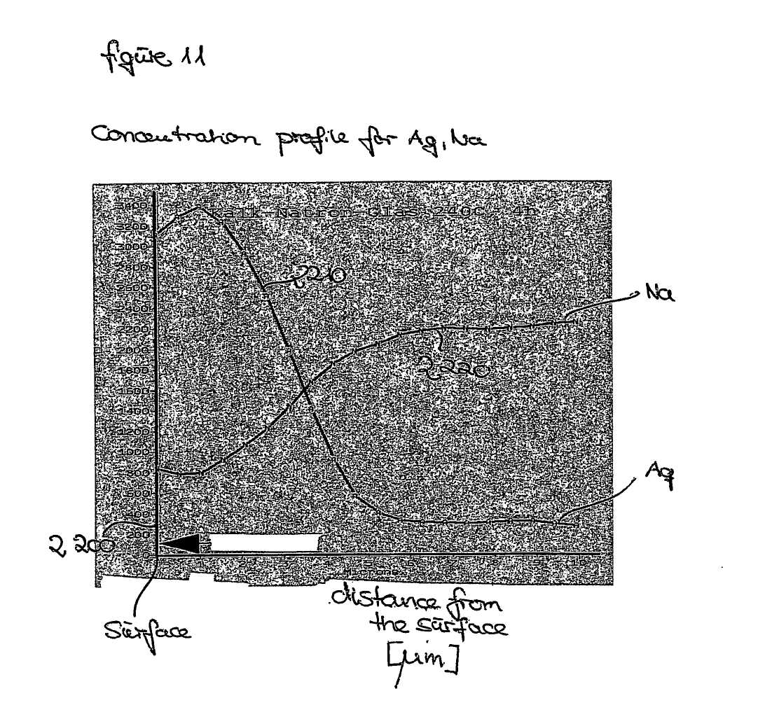

FIG. 11 shows the concentration profile of a soda-lime glass-sample for which in a 100 weight % Ag nitrate melt for 4 hours at temperature of 240 ° C. the ions were exchanged. The silver and Na-content depends from the depth into the substrate with regard to the surface 2200. The curve for Ag is denoted with 2210 and the curve for Na with 2220.

The aforementioned paragraph relates to an ion exchange process which was performed with soda-lime flat glass disks according to a composition of embodiment M2 in table 12.

In table 15 the results of a treatment of glasses according to embodiments M3-M11 in table 12 after the ion exchange process in a 100 weight-% Ag nitrate melt for 100 minutes at temperatures of 250° C. are shown. Table 15 gives the data of the proliferation test.

TABLE 15
results of a proliferation test for glasses according to
embodiment M3-M11 according to table 12 after a ion
exchange process in a 100 weight-% Ag nitrate melt for
100 minutes at a temperature of 250° C.

| | Brutto Onset | |
|---|---|---|
| | OD | Result |
| Emb. M3 | Limit | Antimicrobial |
| Emb. M4 | Limit | Antimicrobial |
| Emb. M5 | Limit | Antimicrobial |
| Emb. M6 | Limit | Antimicrobial |
| Emb. M7 | Limit | Antimicrobial |
| Emb. M8 | Limit | Antimicrobial |
| Emb. M9 | Limit | Antimicrobial |
| Emb. M10 | Limit | antimicrobial |
| Emb. M11 | Limit | antimicrobial |
| positive control | >48 | bactericid |
| negative control | 10.3 | no activity |
| MM Medium | Limit | sterile |
| control sterile | | |

The terms positive control, negative control, MM Medium control sterile are described in T. Bechert, P. Steinrücke, G. Guggenbichler, Nature Medicine, Vol. 6, Number 8, September 2000, S. 1053-1056. The content of this application is fully incorporated in this application.

In table 16 the results are shown for the embodiments M3-M11 without being treated in a Ag-nitrate melt. The samples are comparison examples to the examples shown in FIG. 15.

TABLE 16
results of a proliferation test of embodiments M3-M11 according
to table 12 without treatment in a Ag-nitrate melt

| | Brutto Onset | |
|---|---|---|
| | OD | Result |
| Emb. M3 | | |
| Emb. M4 | 6.8 | non antibacterial |
| Emb. M5 | 8.4 | non antibacterial |
| Emb. M6 | | |
| Emb. M7 | | |
| Emb. M8 | | |
| Emb. M9 | 7.5 | non antibacterial |
| Emb. M10 | | |
| Emb. M11 | | |
| positive control | >48 | bacericide |
| negative control | 6 | no activity |
| MM Medium | Limit | Sterile |
| control sterile | | |

From table 16 it is apparent, that the untreated glasses do not show an antimicrobial effect, whereas the glasses treated in a Ag nitrate melt show an antimicrobial effect.

With the proliferation test it is possible to determine the antimicrobial effect of surfaces.

Onset OD denotes the optical density in a surrounding nutrient medium. By proliferation, i.e. the formation of daughter cells and the release of cells from the surface into the surrounding nutrient medium and therefore the transmission of the nutrient medium is reduced. The absorption at certain wavelengths correlates with the antimicrobial efficiency of the surface. This means high Onset CD values denote a high antimicrobial effect at the surface.

In the following paragraph for glass ceramics it is shown that by a diffusion process a flat glass ceramic plate can be provided with an antimicrobial surface, if the glass ceramic is treated in a Ag nitrate melt. In principle all glass ceramics decribed before, especially the glass ceramics described in EP 1170264, DE 100 17 701, EP 0220333 could be provided with a antimicrobial surface by treating this glass ceramics in a metal containing melt. Therefore the example given below is only exemplary.

The composition of the green glass of the examined glass ceramic is given in weight % an oxide basis in table 17.

TABLE 17
composition of green glass in weight-% on oxide basis
Composition of green glass in weight % on oxide basis

| | |
|---|---|
| Li₂O | 3.5 |
| Na₂O | 0.15 |
| K₂O | 0.2 |
| MgO | 1.15 |
| BaO | 0.8 |
| ZnO | 1.5 |
| Al₂O₃ | 20.0 |
| SiO₂ | 67.2 |
| TiO₂ | 2.6 |
| ZrO₂ | 1.7 |
| As₂O₃ | 1.2 |
| Sum | 100 |

From the green glass composition given above a sheet like glass ceramic was obtained having a thickness of 4 mm by heating the green glass from room temperature to a temperature of 840° C. with a heating rate of 11 K/min. At the temperature of 840° C. the material was hold for 18 minutes. Thereafter the material was heated to 1065° C. with a heating rate of 9,5 K/min. At this temperature the material was hold for 23 minutes. Thereafter the material was cooled to 950° C. with a cooling rate of 12 K/min. From 950° C. the material was cooled to room temperature without a specific cooling rate.

In table 18 the antimicrobial effect of a surface of a sheet like glass ceramic with a green glass composition according to table 17 and prepared as described before which was after ceramization treated in a 100 weight % Ag nitrate melt is shown. In table 18 sample (a) shows a for a sheet like glass ceramic out of a green glass composition given in table 17 which was treated in a 100% weight % Ag nitrate melt for 10 minutes and sample (b) for a sheet like glass ceramic out of a glass ceramic composition given in table 17 treated for 100 minutes at temperatures of 250° C. the antimicrobial effect.

Sample (c) shows for a sheet-like a glass ceramic out of a green glass given in table 17 which was treated in a 100 weight % Zn nitrate melt for 100 minutes at a temperature of 250° C. the antimicrobial effect. As is apparent from table 18 for all samples, sample (a), sample (b) and sample (c), a high Onset OD could be measured, meaning that the samples show a surface with a high antimicrobial effect after treatment in the melt.

TABLE 18
Proliferation test for glass ceramics out of a green glass composition
according to table 17 after treatment in a metal-ion containing melt.

| | Brutto Onset | |
|---|---|---|
| | OD | result |
| Sample (a) | Limit | antimicrobial |
| Sample (b) | Limit | antimicrobial |
| Sample (c) | >37 | antimicrobial |
| positive control | >48 | bactericide |
| negative control | 6 | no activity |
| MM Medium | Limit | sterile |
| control sterile | | |

1-47. (canceled)

48. A method of preparing an article comprising a glass-ceramic substrate with an antimicrobial surface, comprising the steps of:
depositing at least one antimicrobial effective ion or a precursor of the at least one antimicrobial effective ion on at least a part of a surface of the article by a process selected from the group consisting of spraying, rolling, screen printing, printing, dipping, and casting; and
heating the article to a temperature within a temperature range from about 200 degrees Celsius lower than a transformation temperature of a material of the article to about 200 degrees Celsius higher than the transformation temperature of the material of the article for a period from about 2 minutes to about 30 minutes.

49. The method according to claim 48, wherein the temperature range excludes from about 600 degrees Celsius to about 650 degrees Celsius.

50. The method according to claim 48, further comprising between the depositing and heating steps, the step of heating the article to temperatures higher than evaporation temperatures of volatile components to remove the volatile components from the surface.

51. The method according to claim 48, wherein the temperature range is from about 50 degrees Celsius lower than the transformation temperature of the article to about 200 degrees Celsius higher than the transformation temperature of the material of the article and the period is between about 2 minutes and about 15 minutes.

52. The method according to claim 48, wherein the glass-ceramic-substrate is a lithium alumosilicate glass ceramic.

53. The method according to claim 48 further comprising increasing or decreasing the surface area of the glass-ceramic substrate by mechanical grinding and polishing to control the antimicrobial efficacy.

54. The method according to claim 48, wherein the at least one antimicrobial effective ion comprises ions selected from the group consisting of Ag, Zn, Cu, Sn, I, Te, Ge, Cr, and any combinations thereof.

55. The method according to claim 54, wherein the at least one antimicrobial effective ion is deposited as a mixture selected from the group consisting of solutions, suspensions, melts, and pastes, the mixture comprising substances selected from the group consisting of Ag-chloride, Ag-nitrate, Ag-oxide, Ag, Ag-organic compounds, Ag-anorganic compounds, Cu-chloride, Zn-oxide, Zn-nitrate, Zn-chloride, Cu-,Zn-organic compounds, Cu-,Zn-anorganic compounds, Ag salts, Cu salts, Sn salts, Zn salts and any combinations thereof.

56. A method of preparing an article with an antimicrobial surface comprising the steps of:
depositing the article in a melt, wherein the melt comprises at least one antimicrobial effective ion; and
heating the melt with the article to a temperature and for a time sufficient to introduce an antimicrobial effective amount of metal ions into a surface of the article, wherein the article comprises a glass-ceramic-substrate.

57. The method according to claim 56, wherein the temperature is above 200 degrees Celsius and the time is longer than 10 minutes.

58. The method according to claim 56, wherein the at least one antimicrobial effective ion, comprises ions being selected from the group consisting of Ag, Zn, Cu, Sn, I, Te, Ge, Cr, and any combinations thereof.

59. The method according to claim 58, wherein the at least one antimicrobial effective ion is deposited as a mixture selected from the group consisting of solutions, suspensions, melts, and pastes, the mixture comprising substances selected from the group consisting of Ag-chloride, Ag-nitrate, Ag-oxide, Ag, Ag-organic compounds, Ag-anorganic compounds, Cu-chloride, Zn-oxide, Zn-nitrate, Zn-chloride, Cu-,Zn-organic compounds, Cu-,Zn-anorganic compounds, Ag salts, Cu salts, Sn salts, Zn salts, and any combinations thereof.

60. A method of preparing an article with an antimicrobial surface comprising the steps of:
depositing a paste comprising at least one antimicrobial effective ion or a precursor of the at least one antimicrobial effective ion on at least a part of a surface of the article by a process selected from the group consisting of spraying, rolling, screen printing, printing, dipping, and casting; and
heating the article to a temperature and for a time sufficient to introduce an antimicrobial effective amount of the at least one antimicrobial effective ions into a surface of the article, wherein the article comprises a glass-ceramic-substrate.

61. The method according to claim 60, wherein the at least one antimicrobial effective ion comprises ions selected from the group consisting of Ag, Zn, Cu, Sn, I, Te, Ge, Cr, and any combinations thereof.

62. The method according to claim 61, wherein the at least one antimicrobial effective ion is deposited as a mixture selected from the group consisting of solutions, suspensions, melts, and pastes, the mixture comprising substances selected from the group consisting of Ag-chloride, Ag-nitrate, Ag-oxide, Ag, Ag-organic compounds, Ag-anorganic compounds, Cu-chloride, Zn-oxide, Zn-nitrate, Zn-chloride, Cu-,Zn-organic compounds, Cu-,Zn-anorganic compounds, Ag salts, Cu salts, Sn salts, Zn salts and any combinations thereof.

63. A glass ceramic comprising at least a surface comprising metal ions, the surface having a metal ion concentration sufficient to provide an antimicrobial effect.

64. The glass ceramic according to claim 63, wherein the metal ions are ions selected from the group consisting of Ag, Zn, Cu, Sn, I, Te, Ge, Cr, and any combinations thereof.

65. The glass ceramic according to claim 63, wherein the glass ceramic comprises green glass having a composition in weight percent on oxide basis of:

| | |
|---|---|
| SiO₂ | 62-68 |
| Al₂O₃ | 19.5-22.5 |
| Li₂O | 3.0-4.0 |
| Na₂O | 0-1.0 |
| K₂O | 0-1.0 |
| BaO | 1.5-3.5 |
| CaO | 0-1.0 |
| MgO | 0-0.5 |
| ZnO | 0.5-2.5 |
| TiO₂ | 1.5-5.0 |
| ZrO₂ | 0-3.0 |
| MnO₂ | 0-0.40 |
| Fe₂O₃ | 0-0.20 |
| CoO | 0-0.30 |
| NiO | 0-0.30 |
| V₂O₅ | 0-0.80 |
| Cr₂O₃ | 0-0.20 |
| F | 0-0.20 |
| Sb₂O₃ | 0-2.0 |
| As₂O₃ | 0-2.0 |
| ΣNa₂O + K₂O | 0.5-1.5 |
| ΣBaO + CaO | 1.5-4.0 |
| ΣTiO₂ + ZrO₂ | 3.5-5.5 |
| ΣSb₂O₃ + As₂O₃ | 0.5-2.5 |

66. The glass ceramic according to claim 65, wherein the green glass has a composition in weight percent on oxide basis of:

| | |
|---|---|
| Li₂O | 3.0-4.0 |
| Na₂O | 0-1.0 |
| K₂O | 0-0.6 |
| Σ Na₂O + K₂O | 0.2-1.0 |
| MgO | 0-1.5 |
| CaO | 0-0.5 |
| SrO | 0-1.0 |
| BaO | 0-2.5 |
| Σ CaO + SrO + BaO | 0.2-3.0 |
| ZnO | 1.0-2.2 |
| Al₂O₃ | 19.8-23.0 |
| SiO₂ | 66-70 |
| TiO₂ | 2.0-3.0 |
| P₂O₅ | 0-1.0 |

67. The glass ceramic according to claim 63, wherein the green glass of the glass ceramic has a composition in weight percent on oxide basis of:

| | |
|---|---|
| Li₂O | 3.2-5.0 |
| Na₂O | 0-1.5 |
| K₂O | 0-1.5 |
| ΣNa₂O + K₂O | 0.2-2.0 |
| MgO | 0.1-2.2 |
| CaO | 0-1.5 |
| SrO | 0-1.5 |
| BaO | 0-2.5 |
| ZnO | 0-1.5 |
| Al₂O₃ | 19-25 |
| SiO₂ | 55-69 |
| TiO₂ | 1.0-5.0 |
| ZrO₂ | 1.0-2.5 |
| SnO₂ | 0-1.0 |
| ΣTiO₂ + ZrO₂ + SnO₂ | 2.5-5.0 |
| P₂O₅ | 0-3.0 |

68. The glass ceramic according to claim 63, wherein the glass ceramic is a glass ceramic sheet having a side surface, and wherein at least the side surface has the metal ion concentration sufficient to provide the antimicrobial effect.
